(19) United States
(12) Patent Application Publication
(10) Pub. No.: US 2025/0324295 A1
(43) Pub. Date: Oct. 16, 2025

(54) IDLE STATE QUALITY OF EXPERIENCE ACTIVATION AND REPORTING

(71) Applicant: QUALCOMM Incorporated, San Diego, CA (US)

(72) Inventors: Xipeng ZHU, San Diego, CA (US); Shankar KRISHNAN, Poway, CA (US); Jianhua LIU, Beijing (CN)

(21) Appl. No.: 18/867,369

(22) PCT Filed: Aug. 1, 2022
(86) PCT No.: PCT/CN2022/109362

§ 371 Date: Nov. 19, 2024

(51) Int. Cl. H04W 24/08; H04W 24/10

(52) U.S. Cl. CPC H04W 24/08; H04W 24/10

(57) ABSTRACT

Methods, systems, and devices for wireless communication are described. A user equipment (UE) may receive a control message indicating a quality of experience (QoE) measurement activation for a set of QoE measurements by the UE, the control message indicating an application layer identifier associated with the QoE measurement activation. The UE may perform the set of QoE measurements in accordance with the QoE measurement activation. The UE may transmit a QoE reporting message including a measurement collection entity (MCE) identifier that corresponds to the application layer identifier and an indication of the set of QoE measurements.

### CROSS REFERENCE

The present Application is a 371 national phase filing of International PCT Application No. PCT/CN2022/109362 by ZHU et al., entitled “IDLE STATE QUALITY OF EXPERIENCE ACTIVATION AND REPORTING,” filed Aug. 1, 2022, which is assigned to the assignee hereof, and which is expressly incorporated by reference in its entirety herein.

### FIELD OF TECHNOLOGY

The following relates to wireless communication, including idle state quality of experience activation and reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support idle state quality of experience (QoE) activation and reporting. For example, the described techniques provide for QoE reporting after a user equipment (UE) has transitioned to or from an idle or inactive state. For example, the UE may receive or otherwise obtain a control message from a network entity (e.g., a serving cell). The control message may carry or otherwise convey an indication of a QoE measurement activation for a set of QoE measurements to be performed by the UE. The control message may include an application layer QoE identifier (e.g., an identifier (ID) based on the active radio resource control (RRC) connection, RRC ID) associated with the QoE measurement activation. In some aspects, the QoE measurement activation may carry or otherwise convey an indication of a QoE configuration for the activation of the set of QoE measurements or the QoE configuration may be separately indicated or otherwise configured for the UE. The UE may perform the set of QoE measurements according to or otherwise based on the QoE measurement activation (e.g., according to the QoE configuration).

The UE may transmit or otherwise convey a QoE reporting message including a measurement collection entity (MCE) identifier and an indication of the set of QoE measurements. The MCE identifier may include identifying information associated with the MCE activating the set of QoE measurements, such as the MCE address, a unique identifier (e.g., serial number) of the MCE, a reference number associated with the MCE, and the like. That is, the MCE may refer to an entity, function, process, and the like, separate from the wireless network that is associated with QoE measurement requests, receiving QoE measurement results, and processing those results (independently or in cooperation with other(s)) to identify areas of improvement for the user experience. Accordingly, in this context the MCE identifier may be separate from or otherwise different than the RRC ID typically associated with the QoE configuration and measurement reporting. This may enable the network entity to map the MCE identifier to the MCE associated with the QoE measurement activation for routing of the QoE measurement reporting message. In some examples, the indication of the set of QoE measurements may include the QoE measurement results or may include an indication that the QoE measurement results are available for subsequent transmission.

A method for wireless communication at a user UE is described. The method may include receiving a control message indicating a QoE measurement activation for a set of QoE measurements by the UE, the control message indicating an application layer identifier associated with the QoE measurement activation, performing the set of QoE measurements in accordance with the QoE measurement activation, and transmitting a QoE reporting message including a MCE identifier that corresponds to the application layer identifier and an indication of the set of QoE measurements.

An apparatus for wireless communication at a UE is described. The apparatus may include a processor, memory coupled with the processor, and instructions stored in the memory. The instructions may be executable by the processor to cause the apparatus to receive a control message indicating a quality of experience (QoE) measurement activation for a set of QoE measurements by the UE, the control message indicating an application layer identifier associated with the QoE measurement activation, perform the set of QoE measurements in accordance with the QoE measurement activation, and transmit a QoE reporting message including a MCE identifier that corresponds to the application layer identifier and an indication of the set of QoE measurements.

Another apparatus for wireless communication at a UE is described. The apparatus may include means for receiving a control message indicating a QoE measurement activation for a set of QoE measurements by the UE, the control message indicating an application layer identifier associated with the QoE measurement activation, means for performing the set of QoE measurements in accordance with the QoE measurement activation, and means for transmitting a QoE reporting message including a MCE identifier that corresponds to the application layer identifier and an indication of the set of QoE measurements.

A non-transitory computer-readable medium storing code for wireless communication at a UE is described. The code may include instructions executable by a processor to receive a control message indicating a QoE measurement activation for a set of QoE measurements by the UE, the control message indicating an application layer identifier associated with the QoE measurement activation, perform the set of QoE measurements in accordance with the QoE measurement activation, and transmit a QoE reporting message including a MCE identifier that corresponds to the application layer identifier and an indication of the set of QoE measurements.

Some examples of the method, apparatuses, and non-transitory computer-readable medium described herein may further include operations, features, means, or instructions for obtaining, at an access layer of the UE, an indication of the MCE identifier from an application layer of the UE and including, by the access layer, the MCE identifier in the QoE reporting message based on the indication of the MCE identifier obtained from the application layer.

Some examples of the method, apparatuses, and non-transitory computer-readable medium described herein may further include operations, features, means, or instructions for identifying, at the access layer, a mapping of the MCE identifier to the set of QoE measurements based on the control message, where the MCE identifier may be included in the QoE reporting message based on the mapping.

Some examples of the method, apparatuses, and non-transitory computer-readable medium described herein may further include operations, features, means, or instructions for identifying, at an access layer of the UE, a mapping of a unique identifier to the MCE identifier based on the control message, providing, by the access layer, an indication of the QoE measurement activation and the unique identifier to an application layer of the UE, obtaining, from the application layer, an indication of the set of QoE measurements and the unique identifier, and including, by the access layer, the MCE identifier in the QoE reporting message based on the indication of the unique identifier obtained from the application layer.

Some examples of the method, apparatuses, and non-transitory computer-readable medium described herein may further include operations, features, means, or instructions for including, at an access layer of the UE, an indication that the set of QoE measurements may be available for transmission in the QoE reporting message, receiving a bearer configuration for transmission of the set of QoE measurements based on the indication that the set of QoE measurements may be available, and transmitting a subsequent QoE reporting message indicating the set of QoE measurements based on the bearer configuration.

Some examples of the method, apparatuses, and non-transitory computer-readable medium described herein may further include operations, features, means, or instructions for obtaining, at the access layer, the set of QoE measurements from an application layer of the UE, where the indication that the set of QoE measurements may be available may be based on the obtaining.

Some examples of the method, apparatuses, and non-transitory computer-readable medium described herein may further include operations, features, means, or instructions for obtaining, at the access layer, the indication that the set of QoE measurements may be available from an application layer of the UE, where the indication that the set of QoE measurements may be available may be based on the obtaining.

Some examples of the method, apparatuses, and non-transitory computer-readable medium described herein may further include operations, features, means, or instructions for identifying a QoE reporting area for the set of QoE measurements based on the QoE measurement activation, the QoE reporting area being different from or the same as a QoE measurement area for the QoE measurement activation and determining that the UE may be located within the QoE reporting area, where the QoE reporting message may be transmitted based at least part on the UE being located within the QoE reporting area.

Some examples of the method, apparatuses, and non-transitory computer-readable medium described herein may further include operations, features, means, or instructions for identifying the QoE reporting area at an application layer of the UE and based on at least one of the QoE measurement activation or an indication obtained from an access layer of the UE.

Some examples of the method, apparatuses, and non-transitory computer-readable medium described herein may further include operations, features, means, or instructions for identifying the QoE reporting area at an access layer of the UE and based on an indication of the QoE reporting area received via radio resource signaling.

Some examples of the method, apparatuses, and non-transitory computer-readable medium described herein may further include operations, features, means, or instructions for receiving a QoE configuration for the set of QoE measurements from a serving cell of the UE and determining that the MCE identifier may be included in the QoE configuration, where the QoE reporting message may be transmitted based on the MCE identifier being included in the QoE configuration.

In some examples of the method, apparatuses, and non-transitory computer-readable medium described herein, the QoE configuration may be received in at least one a multicast control channel (MCCH) message, a radio resource control (RRC) message, a system information block (SIB) message, or a combination thereof, from the serving cell.

In some examples of the method, apparatuses, and non-transitory computer-readable medium described herein, the MCE identifier includes at least one of an address, identifying information, a reference, a QoE server name, or a combination thereof, for an MCE associated with the QoE measurement activation.

A method for wireless communication at a network entity is described. The method may include transmitting, to a UE, a control message indicating a QoE measurement activation for a set of QoE measurements by the UE, the control message indicating an application layer identifier associated with the QoE measurement activation and receiving, from the UE and based on the QoE measurement activation, a QoE reporting message including a MCE identifier that corresponds to the application layer identifier and an indication of the set of QoE measurements.

An apparatus for wireless communication at a network entity is described. The apparatus may include a processor, memory coupled with the processor, and instructions stored in the memory. The instructions may be executable by the processor to cause the apparatus to transmit, to a UE, a control message indicating a QoE measurement activation for a set of QoE measurements by the UE, the control message indicating an application layer identifier associated with the QoE measurement activation and receive, from the UE and based on the QoE measurement activation, a QoE reporting message including a MCE identifier that corresponds to the application layer identifier and an indication of the set of QoE measurements.

Another apparatus for wireless communication at a network entity is described. The apparatus may include means for transmitting, to a UE, a control message indicating a QoE measurement activation for a set of QoE measurements by the UE, the control message indicating an application layer identifier associated with the QoE measurement activation and means for receiving, from the UE and based on the QoE measurement activation, a QoE reporting message including a MCE identifier that corresponds to the application layer identifier and an indication of the set of QoE measurements.

A non-transitory computer-readable medium storing code for wireless communication at a network entity is described. The code may include instructions executable by a processor to transmit, to a UE, a control message indicating a QoE measurement activation for a set of QoE measurements by the UE, the control message indicating an application layer identifier associated with the QoE measurement activation and receive, from the UE and based on the QoE measurement activation, a QoE reporting message including a MCE identifier that corresponds to the application layer identifier and an indication of the set of QoE measurements.

Some examples of the method, apparatuses, and non-transitory computer-readable medium described herein may further include operations, features, means, or instructions for mapping the MCE identifier to the set of QoE measurements, where the control message indicates the mapping.

In some examples of the method, apparatuses, and non-transitory computer-readable medium described herein, the indication of the set of QoE measurements includes the set of QoE measurements.

Some examples of the method, apparatuses, and non-transitory computer-readable medium described herein may further include operations, features, means, or instructions for identifying an indication that the set of QoE measurements may be available for transmission based on the QoE reporting message, transmitting a bearer configuration for transmission of the set of QoE measurements based on the indication that the set of QoE measurements may be available, and receiving a subsequent QoE reporting message indicating the set of QoE measurements.

Some examples of the method, apparatuses, and non-transitory computer-readable medium described herein may further include operations, features, means, or instructions for indicating a QoE reporting area for the set of QoE measurements based on the QoE measurement activation, the QoE reporting area being different from or the same as a QoE measurement area for the QoE measurement activation and receiving the QoE reporting message based on the UE being located within the QoE reporting area.

Some examples of the method, apparatuses, and non-transitory computer-readable medium described herein may further include operations, features, means, or instructions for transmitting a QoE configuration including the MCE identifier for the set of QoE measurements, where the QoE reporting message may be received based on the MCE identifier being included in the QoE configuration.

In some examples of the method, apparatuses, and non-transitory computer-readable medium described herein, the QoE configuration may be transmitted in at least one a MCCH message, an RRC message, an SIB message, or a combination thereof, from the network entity.

In some examples of the method, apparatuses, and non-transitory computer-readable medium described herein, the MCE identifier includes at least one of an address, identifying information, a reference, a QoE server name, or a combination thereof, for an MCE associated with the QoE measurement activation.

### BRIEF DESCRIPTION OF THE DRAWINGS

FIG. 1 illustrates an example of a wireless communications system that supports idle state quality of experience (QoE) activation and reporting in accordance with one or more aspects of the present disclosure.

FIG. 2 illustrates an example of a wireless communication system that supports idle state QoE activation and reporting in accordance with one or more aspects of the present disclosure.

FIG. 3 illustrates an example of a method that supports idle state QoE activation and reporting in accordance with one or more aspects of the present disclosure.

FIG. 4 illustrates an example of a method that supports idle state QoE activation and reporting in accordance with one or more aspects of the present disclosure.

FIG. 5 illustrates an example of a method that supports idle state QoE activation and reporting in accordance with one or more aspects of the present disclosure.

FIGS. 6 and 7 show block diagrams of devices that support idle state QoE activation and reporting in accordance with one or more aspects of the present disclosure.

FIG. 8 shows a block diagram of a communications manager that supports idle state QoE activation and reporting in accordance with one or more aspects of the present disclosure.

FIG. 9 shows a diagram of a system including a device that supports idle state QoE activation and reporting in accordance with one or more aspects of the present disclosure.

FIGS. 10 and 11 show block diagrams of devices that support idle state QoE activation and reporting in accordance with one or more aspects of the present disclosure.

FIG. 12 shows a block diagram of a communications manager that supports idle state QoE activation and reporting in accordance with one or more aspects of the present disclosure.

FIG. 13 shows a diagram of a system including a device that supports idle state QoE activation and reporting in accordance with one or more aspects of the present disclosure.

FIGS. 14 through 18 show flowcharts illustrating methods that support idle state QoE activation and reporting in accordance with one or more aspects of the present disclosure.

### DETAILED DESCRIPTION

Wireless cellular networks may support quality of service (QoS) as well as quality of experience (QoE) feedback configuration and support. QoS operations identify or otherwise determine how well the wireless network is performing based on measurements derived or otherwise determined based on measurable physical channel performance metrics (e.g., based on the physical or access layer of the radio access network (RAN)). QoE operations are based more on the subjective experience as reported by the end-user when interacting with a service, application, process, etc., being performed on a device operating over the wireless network.

QoE operations are based on QoE parameters provided by and/or for a measurement collection entity (MCE). For example, a MCE may activate a user equipment (UE) operating in a radio resource control (RRC) connected state to perform MCE measurements via the RAN using RRC or other signaling. The MCE may configure the UE to perform the QoE measurements according to certain QoE parameters. Such signaling may be received at an access layer of the UE, which may interact with the application layer of the UE. The QoE measurements may be performed and collected at the application layer of the UE. The QoE process may be tracked between the access and application layers of the UE, as well as by the network device within the RAN, based on an application layer QoE identifier (ID) that is derived or otherwise based on an RRC identifier derived for or from the active RRC state of the UE. However, the RRC based identifier (e.g., RRC ID) may be released or otherwise dropped when the UE transitions from the RRC active or connected state to an RRC idle state or inactive state. As a result, the UE may have QoE measurements to report to the network, but be unable to track the QoE measurements within the RAN or core network back to the original MCE request.

The described techniques relate to improved methods, systems, devices, and apparatuses that support QoE reporting after a UE has transitioned to or from an idle or inactive state. For example, the UE may receive or otherwise obtain a control message from a network entity (e.g., a serving cell). The control message may carry or otherwise convey an indication of a QoE measurement activation for a set of QoE measurements to be performed by the UE. The control message may include an application layer QoE identifier (e.g., an identifier based on the active RRC connection, RRC ID) associated with the QoE measurement activation. In some aspects, the QoE measurement activation may carry or otherwise convey an indication of a QoE configuration for the activation of the set of QoE measurements or the QoE configuration may be separately indicated or otherwise configured for the UE. The UE may perform the set of QoE measurements according to or otherwise based on the QoE measurement activation (e.g., according to the QoE configuration).

The UE may transmit or otherwise convey a QoE reporting message including a MCE identifier and an indication of the set of QoE measurements. The MCE identifier may include identifying information associated with the MCE activating the set of QoE measurements, such as the MCE address, a unique identifier (e.g., serial number) of the MCE, a reference number associated with the MCE, or other information that can be used to identify and distinguish the MCE. Accordingly, in this context the MCE identifier may be separate from or otherwise different than the RRC ID typically associated with the QoE configuration and measurement reporting. This may enable the network entity to map the MCE identifier to the MCE associated with the QoE measurement activation for routing of the QoE measurement reporting message. In some examples, the indication of the set of QoE measurements may include the QoE measurement results or may include an indication that the QoE measurement results are available for subsequent transmission.

Aspects of the disclosure are initially described in the context of wireless communications systems. Aspects of the disclosure are further illustrated by and described with reference to apparatus diagrams, system diagrams, and flowcharts that relate to idle state QoE activation and reporting.

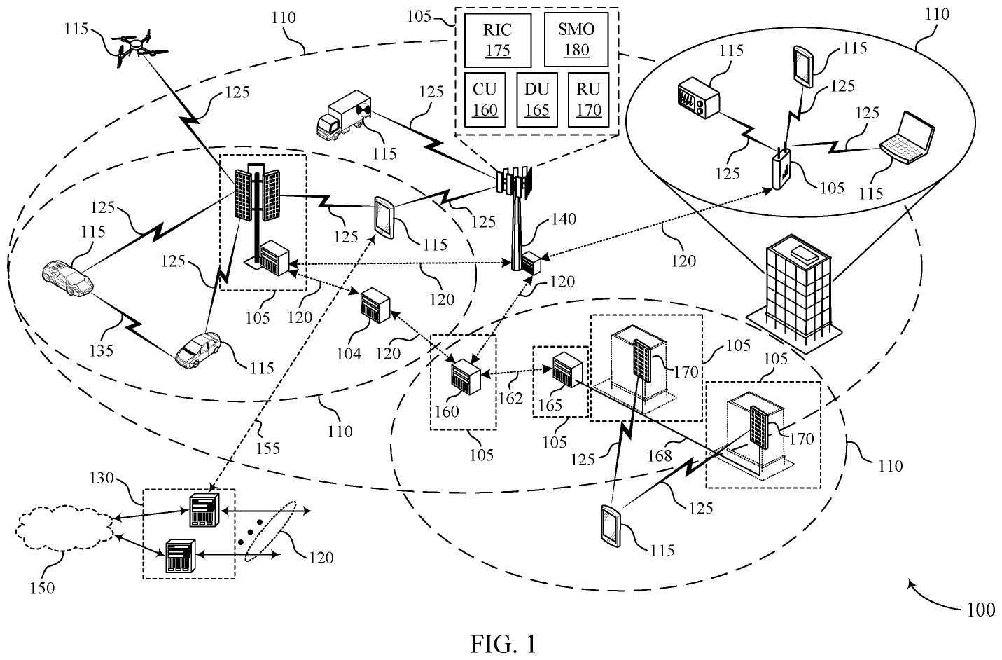

FIG. 1 illustrates an example of a wireless communications system 100 that supports idle state QoE activation and reporting in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support idle state QoE activation and reporting as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ−N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive a control message indicating a QoE measurement activation for a set of QoE measurements by the UE 115, the control message indicating an application layer identifier associated with the QoE measurement activation. The UE 115 may perform the set of QoE measurements in accordance with the QoE measurement activation. The UE 115 may transmit a QoE reporting message including a MCE identifier that corresponds to the application layer identifier and an indication of the set of QoE measurements.

A network entity 105 may transmit, to a UE 115, a control message indicating a QoE measurement activation for a set of QoE measurements by the UE 115, the control message indicating an application layer identifier associated with the QoE measurement activation. The network entity 105 may receive, from the UE 115 and based at least in part on the QoE measurement activation, a QoE reporting message including a MCE identifier that corresponds to the application layer identifier and an indication of the set of QoE measurements.

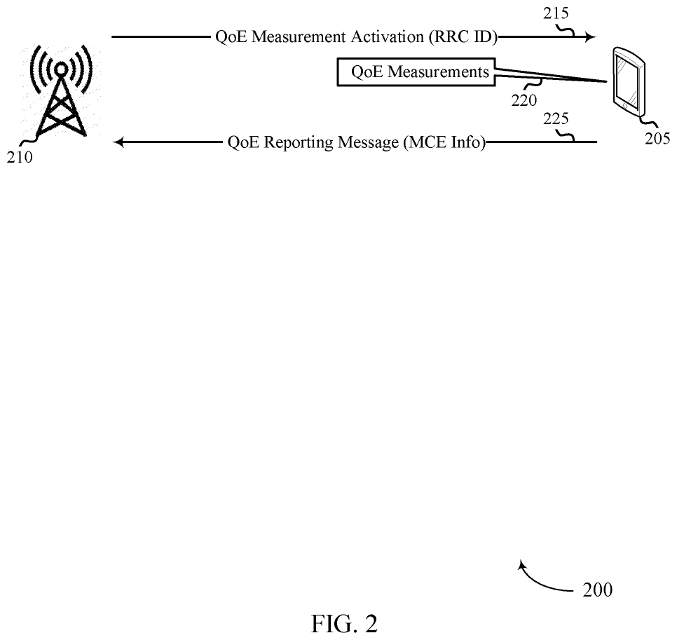

FIG. 2 illustrates an example of a wireless communication system 200 that supports idle state QoE activation and reporting in accordance with one or more aspects of the present disclosure. Wireless communication system 200 may implement aspects of wireless communication system 100. Wireless communication system 200 may include a UE 205 and a network entity 210, which may be examples of the corresponding devices described herein.

Wireless communication system 200 may support QoE measurement configuration and collection in the context of the UE 205 being in an RRC idle or inactive state. QoE operations include an application layer measurement configuration received from the operation, administration, and maintenance (OAM) function or core network (e.g., via the RAN, such as via the network entity 210) that is encapsulated in a transparent container, which is forwarded to the UE 205 in a downlink RRC message. Application layer measurements received from a UE's higher layer (e.g., received at an access layer from the application layer) may be encapsulated in a transparent container and sent to network in an uplink RRC message. QoE reports are sent via a separate signaling radio bearer (SRB) (e.g., separate from a current SRBs) in wireless communication networks (e.g., as this reporting is considered lower priority than other SRB transmissions). RRC signaling may be used by the network entity 210 to indicate to the UE 205 to pause or resume the QoE measurement and reporting. The details of pause or resume mechanism may vary (e.g., is the pause or resume for all QoE reports or on a per-QoE configuration, how long can the UE store the reports, limit for stored reports size, and so forth).

More particularly, some QoE measurement and reporting techniques may include a signaling based NR QoE activation procedure. The OAM may initiate the QoE measurement activation for a specific UE via the core network (e.g., via the NG-RAN node, such as the network entity 210). Other techniques may include a management based NR QoE activation procedure may include the OAM sending one or more QoE measurement configurations to the NG-RAN node. That is, for signaling-based QoE measurements the OAM may initiate the QoE measurement activation for a specific UE via the core network and the NG-RAN node. For management-based QoE measurement activation, the OAM sends one or more the QoE measurement configurations to the NG-RAN node.

Broadly, the NG-RAN node (e.g., the network entity 210) may receive or otherwise obtain one or more QoE measurement configurations from OAM (e.g., in management-based QoE measurement) or core network (e.g., in signaling-based QoE measurement). In some aspects, each QoE configuration may include: a QMC configuration container (XML file), a QoE reference, a service type, an MCE IP address, an area scope, a slice scope, minimization of drive test (MDT) alignment information, and available RAN visible QoE metrics. The NG-RAN node (e.g., the network entity 210) may send the QoE configuration to the UE 205 via a control message (e.g., RRCReconfiguration message) that includes: the QMC configuration container (XML file), a measConfigAppLayerID (e.g., application layer identifier), and the service type.

The application layer identifier (e.g., measConfigAppLayerID) is derived from or otherwise based on the UE 205 operating in an RRC idle state (e.g., an RRC ID). More particularly, for each QoE measurement configuration (QMC), there is one identifier. In the application layer or MCE (e.g., OAM server), this may include using the QoE reference to identify each QMC job. The QoE reference may be globally unique and composed based on a mobile country code (MCC), a mobile network code (MNC), and a QMC identifier. The QoE reference is included in application layer configuration container and the QoE report container.

At the RRC layer (e.g., at the access layer, which may include one or more layers involved in the access stratum (AS) such as the RRC layer, the physical layer, etc.), this may include using the application layer identifier (e.g., measConfigAppLayerID) to identify one QoE configuration. The application layer identifier (e.g., measConfigAppLayerID) may be allocated by the NG-RAN using a 4-bit length, for example. For each UE, there may be a 1:1 mapping between the measConfigAppLayerID and the QoE reference, and the mapping is maintained in NG-RAN.

UE RRC layer may forward the measConfigAppLayerID together with the QoE configuration container to the application layer. The application layer may deliver, signal or otherwise include the measConfigAppLayerID together with QoE report container. The UE RRC layer (e.g., the application layer) does not maintain or is otherwise not aware of the mapping between the measConfigAppLayerID and the QoE reference. The NG-RAN determines the MCE address based on the received measConfigAppLayerID included in RRC report message. Accordingly, the mapping between measConfigAppLayerID and QoE Reference is maintained in the NG-RAN.

Wireless communication system 200 may also support aspects of QMC deactivation and release. For example, conditions may be established or otherwise configured to deactivate or release the QMC. OAM may trigger deactivation of a list of QoE measurement collection job(s) (e.g., different QoE measurement configurations). The deactivation of a QoE measurement collection may be achieved by providing a list of QoE references corresponding to each QoE configuration. The network entity 210 may release one or multiple application layer measurement configurations from the ULE 205 in one RRCReconfiguration message at any time. If the UE 205 enters an RRC idle or inactive state, conventional techniques include the UE 205 releasing all of the QoE measurement configurations. Upon reception of a release command, the UE 205 may, when one QoE measurement configuration is released, include the RRC layer informing the upper layer (e.g., the application layer) to release the QoE measurement configuration.

Some QoE reporting techniques (e.g., where the UE 205 transmits a report of the QoE measurement results to the OAM or MCE via the NG-RAN) may also be supported by wireless communication system 200. As discussed, the QoE measurement collection is handled at the application layer. The QoE report container may be received from the application layer at the RRC layer (e.g., the access layer). For example, the application layer QoE measurement reports may be encapsulated in a transparent container in carried or otherwise conveyed in a QoE measurement report message (e.g., MeasurementReportAppLayer RRC message) to the OAM or MCE via the NG-RAN (e.g., over SRB4). The application layer identifier (e.g., measConfigAppLayerId) may be used to identify one application layer measurement configuration and report (e.g., the corresponding QoE configuration or QmC) within the NG-RAN (e.g., between the UE 205 and the network entity 210). The application layer measurement report is forwarded to OAM together with the QoE Reference based on the mapping between the application layer identifier and the MCE reference (or other information used to identify or otherwise distinguish the OAM or MCE associated with the QoE configuration. In some examples, segmentation of the MeasurementReportAppLayer message may be enabled to allow the transmission of application layer measurement reports that exceed the maximum packet data convergence protocol (PDCP) service data unit (SDU) size limit. Existing RRC segmentation mechanisms may be applied.

However, such conventional QoE measurement and reporting techniques rely on the mapping between the MCE reference (or other identifying information for the OAM or MCE) and the application layer identifier to properly report QoE measurement results. When the UE 205 enters the RRC connected state, the UE 205 may report the buffered QoE data (e.g., the results of the QoE measurements performed according to a specific QoE configuration) to the NG-RAN (e.g., the network entity 210) for forwarding on to the OAM or MCE. For a UE operating in the RRC connected state, the QoE configuration is identified by or otherwise based on the RRC ID, such RRC ID being allocated by the network entity 210 during connection establishment. When the UE 205 reports the QoE data to the network entity 210, the UE 205 may indicate the RRC ID (e.g., the application layer identifier) for each QoE report. The network entity 210 stores the association between the QoE reference or MCE address and the RRC ID and derives the QoE reference and MCE address based on the RRC ID. During a handover scenario, the association (e.g., the mapping) may be forwarded to the target gNB.

However, such active state-based QoE configuration and report mechanisms defined for connected state will not work during RRC idle or inactive operations. As one non-limiting example, because there is QoE configuration area scope, the UE 205 may move outside of the area scope and may be connected with a network entity not configured with the corresponding QoE configuration. Another example may be based on the UE 205 operating in the RRC idle or inactive state where the QoE context is released in the idle state and the network entity 210 cannot identify the RRC ID. That is, the RRC ID (e.g., the application layer ID) included in the messages exchanged between the application and access layers of the UE 205 or in the messages exchanged within the NG-RAN during QoE measurement reporting and used to map the QoE results to the appropriate OAM or MCE are dropped or otherwise released when the UE 205 transitions out of the RRC active state. When the UE 205 is operating in the idle state, the UE 205 may perform QoE measurements and store (e.g., buffer) the QoE measurement results. As the UE 205 has lost the RRC ID, this creates a situation where the UE 205 has stored QoE measurement results after transitioning back to the RRC connected state, but no identifier or other mechanism to route the QoE measurement results back to the associated OAM or MCE.

Accordingly, aspects of the techniques described herein provide one or more techniques to address how the UE 205 reports QoE data (e.g., a set of QoE measurements, which correspond to the QoE configuration or QoE measurement results) to the network entity 210 when the UE 205 operating in an idle state moves outside of the QoE area scope or simply transitions back to the connected state from an idle state. In some examples, this may include the UE 205 indicating MCE information (e.g., an MCE identifier, which includes any information usable to identify and distinguish the OAM or MCE associated with the QMC) in its QoE reporting message. In some examples, this may include the network entity 210 forwarding the QoE data (e.g., the QoE measurement results, which may include the set of QoE measurements) to the MCE according to the MCE information. In some examples, this may include the UE 205 reporting to the network entity 210 whether there is QoE data (e.g., the set of QoE measurements) available for one QoE configuration where the network entity 210 may request the UE 205 to report QoE data for the QoE configuration. In some examples, this may include configuring a QoE reporting area to the UE 205, where the UE 205 reports QoE data if it is within the QoE reporting area.

This may include the network entity 210 transmitting or otherwise providing (and the UE 205 receiving or otherwise obtaining) a control message 215. The control message 215 may carry or otherwise convey an indication of a QoE measurement activation for a set of QoE measurements. The set of QoE measurements may refer the QoE measurement configuration (e.g., the QMC) or the results of QoE measurements performed according to a QMC and for an OAM or MCE. For example, the control message 215 may carry or otherwise convey an indication of the QMC configuration container (e.g., XML file, which may be application layer information invisible to the access layer, such as the RRC layer), the application layer identifier (e.g., measConfigAppLayerID), and the service type. The control message 215 may be transmitted or otherwise conveyed in an RRC control message, such as an RRC reconfiguration message. The control message indicating the QoE measurement activation may be received at the network entity 210 via the core network from the OAM or MCE (e.g., in the signaling based QoE measurements) or directly from the OAM or MCE (e.g., in the management based QoE measurements).

The UE 205 may perform the set of QoE measurements at 220 in accordance with the QoE measurement activation. That is, the UE 205 may use the QMC to identify the measurement objects or features (such as solicit feedback from the end-user, autonomously from related information, or both) and measure those objects or features according to the QMC to obtain QoE measurement results. The UE 205 may transmit or otherwise provide (and the network entity 210 may receive or otherwise obtain) a QoE reporting message 225. The QoE reporting message 225 may include a MCE identifier as well as an indication of the set of QoE measurements (e.g., the QoE measurement results in some examples, or an indication that the results are available for transmission in other examples). In some aspects, the MCE identifier corresponds to or is otherwise based on the application layer identifier. That is, the MCE identifier may be different from the application layer identifier (e.g., measConfigAppLayerID, such as the RRC ID), but may correspond to the RRC ID such that QoE measurement result reporting may be performed to the associated OAM or MCE.

More particularly, the MCE identifier may be different from the RRC ID, but still usable to identify or otherwise distinguish the OAM or MCE associated with the MCQ used to obtain the QoE measurement results. The MCE identifier may include any information that can be used to link the QoE measurement results (e.g., the set of QoE measurements) indicated in the QoE reporting message 225. Examples of information that may be used as the MCE identifier or from which the MCE identifier may be based include, but are not limited to, an address (such as an IP address, MAC address, etc.), identifying information (e.g., broadly any identifying information), a reference (such as the QoE reference or otherwise reference information), a QoE server name, or a combination thereof, for the MCE (e.g., MCE or OAM) associated with the QoE measurement activation. In some examples, the MCE identifier may also be referred to as MCE information.

In some aspects, this may include the UE 205 indicating the MCE information (e.g., MCE identifier) in the QoE reporting message 225. For example, the access layer of the UE 205 may receive or otherwise obtain an indication of the MCE identifier from the application layer of the UE 205. The access layer in this example may include the MCE identifier in the QoE reporting message 225 in response to or otherwise based on the indication of the MCE identifier received from the application layer. For example, the access layer may identify or otherwise determine the mapping of or between the MCE identifier and the set of QoE measurements based on the control message 215. For example, the access layer in this example may generate, store, or otherwise use the mapping when routing the QoE reporting message 225 to the correct OMA or MCE. Again the MCE identifier (e.g., MCE information) may correspond to the QMC of a MCE or OAM, which may include the MCE address, identifying information of the MCE, QoE reference, and the like.

More particularly, in some examples the access layer (e.g., AS layer) of the UE 205 may receive or otherwise obtain the MCE identifier from the application layer. The application layer may provide the MCE information to the access layer when delivering the QoE measurements to the access layer. In some examples, the application layer may be configured with the MCE information by the MCE server (e.g., OAM or MCE) in the QoE configuration container. In some examples, the network entity 210 may configure the MCE information to the access layer of the UE 205 and the access layer may forward the MCE identifier to the application layer with the QoE configuration.

In some examples, this may include using a unique identifier the access layer of the UE 205 identifying or otherwise determining a mapping between a unique identifier and the MCE identifier based on the control message 215. For example, the access layer of the UE 205 may transmit or otherwise provide an indication of the QoE measurement activation along with the unique identifier to the application layer of the UE 205. The application layer of the UE 205 may include the indication of the unique identifier in its reporting of the QoE measurement results (e.g., the set of QoE measurements) to the access layer. The access layer may include the MCE identifier in the QoE reporting message 225 based on the indicated unique identifier obtained from the application layer. That is, the access layer of the UE 205 may maintain the mapping between the unique identifier or number and the MCE identifier and include the MCE identifier in the QoE reporting message 225 based on matching the unique identifier to the MCE information or QMC.

More particularly, in some examples the network entity 210 may configure the access layer of the UE 205 with one ID (e.g., the unique identifier) and the corresponding or associated MCE information. The access layer may forward the unique identifier and the QoE configuration to the application layer of the UE 205. The application layer may provide the unique identifier and the QoE measurement results to the access layer. The access layer derives the MCE information from the unique identifier and includes the MCE information in the QoE reporting message 225 based on the derivation.

Accordingly, including the MCE information in the QoE reporting message 225 provide a mechanism for the UE 205 to successfully report buffered QoE measurement results after operating in an RRC idle or inactive state. Although the examples are described in the context of the UE 205 operating in the idle or inactive states, it is to be understood that the techniques discussed herein may equally be implemented in RRC connected QoE operations where the application layer identifier is dropped in favor of using the MCE information within the RAN for QoE measurements and reporting. Accordingly, the techniques described herein may be equally applicable without the UE 205 operating in the idle or inactive states.

The MCE identifier corresponds to the application layer identifier in that the application layer identifier may correspond to the same QMC from which the QoE measurements are performed (e.g., as may be included in the QoE measurement activation). However, it is to be understood that in some examples the application layer identifier may be dropped from QoE measurement and reporting operations entirely in favor of using the MCE identifier instead. In these examples, references to the application layer identifier may refer to the MCE identifier being used instead of the application layer identifier.

In some examples a QoE reporting area may be optionally configured as part of the QMC signaling. For example, the QoE measurement activation (e.g., control message 215) may carry or otherwise convey an indication of a QoE reporting area that identifies or otherwise defines a geographical area that the UE 205 may be located within in order to support QoE measurement result reporting using the MCE information, such as using the techniques described herein. The QoE reporting area may be the same as (e.g., correspond to) the QoE measurement area (e.g., the area scope, which may define the area in which the UE 205 performs QoE measurements) or may be different from the QoE measurement area. If the UE 205 identifies or otherwise determines that it is located within the QoE reporting area, the UE 205 may transmit the QoE reporting message 225. If the UE 205 identifies or otherwise determines that it is not located with the QoE reporting area, the UE 205 may not transmit the QoE reporting message 225 and, instead, may drop those buffered QoE measurement results.

More particularly, the UE 205 may report the QoE data (e.g., the QoE measurement results) in the configured area (e.g., the QoE measurement area). When the UE 205 is configured with a specific QoE reporting area (e.g., based on cells, or tracking areas (TAs), or frequencies) for QoE reporting, the UE application layer may identify or otherwise determine whether the UE 205 is located in the QoE reporting area report available QoE data based on the determining. The QoE reporting area may be configured by the MCE server to the application layer or may be configured by the network entity 210 to the access layer of the UE 205 and the access layer provides an indication of the QoE reporting area to the application. Accordingly, the QoE reporting area may be identified or otherwise determined at the application layer (e.g., based on the QoE measurement activation or from the access layer) or at the access layer (e.g., based on RRC signaling) of the UE 205. The QoE reporting area can be configured by the network entity 210 to the UE access layer using RRC, in some examples. The QoE reporting area may be configured on a per-QoE configuration basis (e.g., on a per-QMC basis). Each network entity (such as the network entity 210) located within the QoE reporting area may be configured with the QoE configurations.

Accordingly, the network entity 210 may transmit or otherwise provide the QoE measurements results for the QMC (e.g., the set of QoE measurements) to the appropriate OAM or MCE based on the mapping between the MCE information and the QMC (e.g., based on the MCE reference or other identifying information). In the situation where the MCE identifier is, or is otherwise based on, the MCE address, the network entity 210 may forward the QoE data (e.g., the QoE measurement results for the QMC) to the OAM or MCE based on the MCE address. In the situation where the MCE identifier is an identifier of the MCE (e.g., a unique serial number or other identifier, such as the QoE reference), the network entity 210 may translate (e.g., match) the identifier of the MCE or QoE reference to the MCE identifier to determine the MCE address. Network entity 210 may forward the QoE data (e.g., the QoE measurement results) to the OAM or MCE using the MCE address.

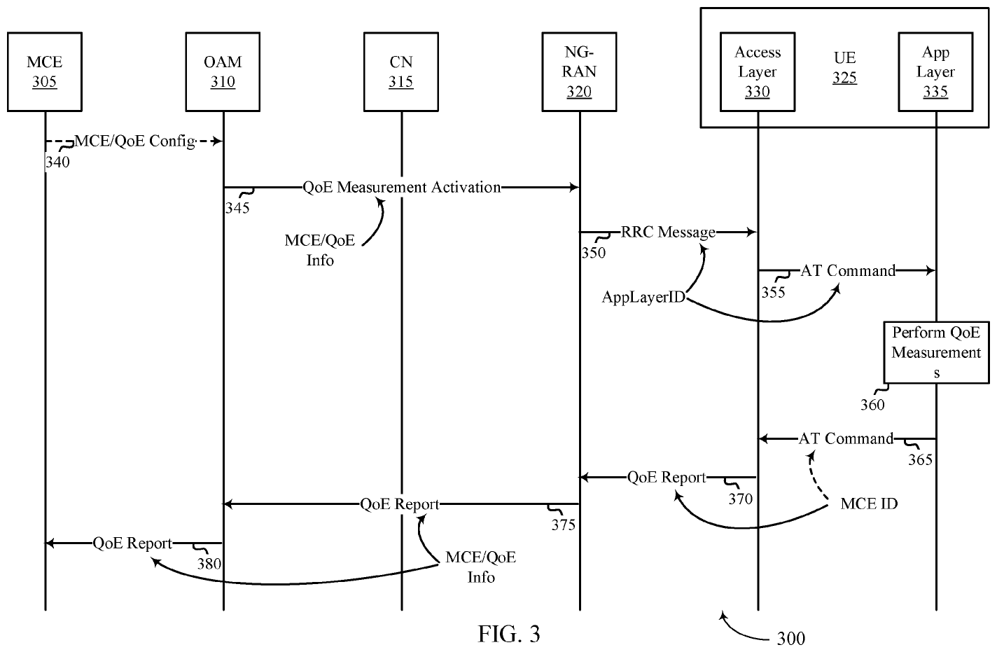

FIG. 3 illustrates an example of a method 300 that supports idle state QoE activation and reporting in accordance with one or more aspects of the present disclosure. Method 300 may implement aspects of wireless communication systems 100 or 200. Aspects of method 300 may be implemented at or implemented by MCE 305, OAM 310, core network (CN) 315, NG-RAN 320, or the UE 325, which may be examples of the corresponding devices discussed herein. In some aspects, OAM 310 may be a component of or otherwise work in cooperation with CN 315. In some aspects, NG-RAN 320 may correspond to the wireless interface between the UE 325 and CN 315, which may include the network entity in some examples. In some aspects, the UE 325 may include an access layer 330 and an application layer 335. As discussed, references to the access layer 330 of the UE 325 may include any function, process, or layer associated with the AS, such as the RRC layer, physical layer, and the like.

At 340, MCE 305 may optionally transmit, provide, or otherwise convey (and OAM 310 may optionally receive, obtain, or otherwise determine) an MCE or QoE configuration (e.g., a QMC). As discussed above, the MCE 305 may refer to any entity supporting collection and analysis of QoE measurement information. MCE 305 may be associated with the network operator associated with CN 315 or may be independent of the cellular network. In some examples, MCE 305 may be part of a service provider providing various features, applications, functions, and the like, for use by an end-user (e.g., such as services, functions, applications, and the like, operating on the UE 325). MCE 305 may transmit the QMC to OAM 310 to initiate QoE measurement and reporting operations by the end-user using the UE 325. In some examples, MCE 305 may be separate from the service provider, but acting on behalf of the service provider when establishing the QMC to support QoE measurement and reporting operations.

At 345, OAM 310 may transmit or otherwise provide a QoE measurement activation to NG-RAN 320. In signaling-based QoE measurements, OAM 310 may provide the indication of the QoE measurement activation via CN 315 or directly to NG-RAN 320 in management-based QoE measurement activation. As discussed above, the QoE measurement activation (e.g., the QoE configuration, or simply QMC) may include the QMC configuration container (e.g., the XML file), the QoE reference, the service type, and so forth as discussed above.

At 350, NG-RAN 320 may transmit or otherwise provide (and the UE 325 may receive or otherwise obtain) an RRC message (e.g., a control message, such as an RRC reconfiguration message) to access layer 330 of the UE 325. The RRC message may carry or otherwise convey an indication of the application layer identifier (e.g., measConfigAppLayerID), the QMC configuration container, and the service type, in some examples.

At 355, the access layer 330 may transmit or otherwise provide (and the application layer 335 may receive or otherwise obtain) an attention (AT) command forwarding the QMC configuration container, the service type, and application layer identifier. The AT command serves as an instruction from one layer to another to perform a certain action or process. In this context, this may provide an indication to the application layer to activate or otherwise initiate QoE measurements according to the QMC.

Accordingly and at 360, the application layer of the UE 325 may perform QoE measurements in accordance with the QoE measurement activation. This may result in the application layer 335 measuring, identifying, or otherwise determining a set of QoE measurement results based on the activated QoE measurements an in accordance with the QMC.

At 365, the application layer 335 may transmit or otherwise provide (and the access layer 330 may receive or otherwise obtain) an AT command including the MCE identifier and information associated with the QoE measurement results (e.g., the QoE measurement results or an indication that the QoE measurement results are available).

At 370, the access layer 330 of the UE 325 may transmit or otherwise convey (and NG-RAN 320 may receive or otherwise obtain) a QoE reporting message including the MCE identifier and the information associated with the QoE measurement results. As discussed above, in some examples the access layer 330 may include the MCE identifier in the QoE reporting message based on the indication received from the application layer (e.g., simply forward the MCE identifier in the QoE reporting message) or may receive an indication of the mapping of the MCE identifier to the set of QoE measurement results.

At 375, the NG-RAN 320 may transmit or otherwise provide (and OAM 310 may receive or otherwise obtain) the QoE measurement results in a QoE report. For example, the NG-RAN 320 may be configured with or otherwise store a mapping between the MCE identifier and the OAM or MCE associated with the QMC. NG-RAN 320 (e.g., a network entity) may identify routing or destination information for the OAM or MCE based on the mapping and forward the QoE report to the appropriate entity accordingly. As discussed above, the QoE report may be sent directly to the OAM 310 or via CN 315.

At 380, OAM 310 may transmit or otherwise provide (and MCE 305 may receive or otherwise obtain) the QoE report conveying the set of QoE measurements (e.g., the QoE measurement results for the QMC). As in 340, the QoE reporting from the OAM 310 to the MCE 305 may be optional, depending on how or which entity has initiated the QMC for the UE 325.

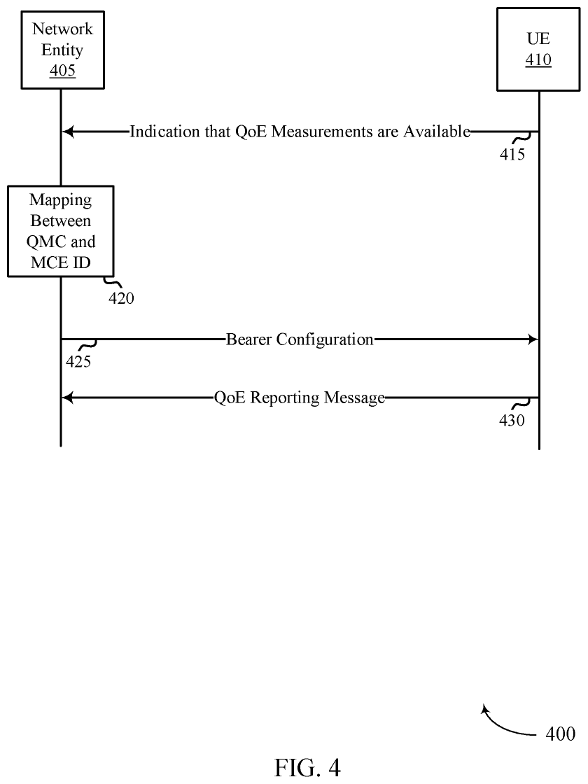

FIG. 4 illustrates an example of a method 400 that supports idle state QoE activation and reporting in accordance with one or more aspects of the present disclosure. Method 400 may implement aspects of wireless communication systems 100 or 200 or aspects of method 300. Aspects of method 400 may be implemented at or implemented by the network entity 405 or the UE 410, which may be examples of the corresponding devices described herein.

As discussed above, aspects of the techniques described herein support improved QoE reporting techniques based on a MCE identifier included in the QoE reporting message. The NG-RAN may maintain, identify, or otherwise determine a mapping between the MCE identifier and the MCE or OAM associated with a QMC. The NG-RAN (e.g., the network entity 405) may map the MCE identifier in the QoE reporting message to the OAM or MCE and route the QoE report to the appropriate entity according to the mapping. Method 400 illustrates a non-limiting example where the UE 410 queries or otherwise signals the availability of the set of QoE measurements (e.g., the QoE measurement results) to the network entity 405 before sending the QoE reporting message.

At 415, this may include the UE 410 transmitting or otherwise providing (and the network entity 405 receiving or otherwise obtaining) an indication that QoE measurements are available. For example, the UE 410 may transmit a QoE reporting message including the MCE identifier and indication that the set of QoE measurements are available. That is, the indication of the set of QoE measurements in the example illustrated in method 400 includes an indication that the QoE measurement results are available rather than the actual QoE measurement results. In some aspects, this may include the access layer of the UE 410 indicating to the network entity 405 the QoE reference or MCE identifier for which there is or is not QoE data available (e.g., the QoE measurement results). Accordingly, the access layer of the UE 410 may identify or otherwise determine whether there is QoE data available for a particular QMC.

In some aspects, this may be based on exchanges between the access layer and the application layer of the UE 410. In some example, the access layer may obtain the set of QoE measurements from the application layer (e.g., the actual QoE measurement results) and include the indication that the set of QoE measurements are available based on the indication received from the application layer. In other examples, the access layer may simply obtain an indication from the application layer that the set of QoE measurements are available and relaying the indication in the signaling to the network entity 405. Accordingly, in some examples the access layer determines whether there is or is not QoE measurement results received from the application layer while in other examples the access layer may determine where there is or is not an indication of the available QoE measurement results received from the application layer. The application layer may identify or otherwise determine the MCE identifier or QoE reference according to the techniques discussed above (e.g., included in the QMC configuration container hidden from the access layer or separately signaled to the access layer from the network).

At 420, the network entity 405 may identify or otherwise whether there is a mapping between the MCE identifier and a QMC (e.g., a QoE configuration known by the network entity 405). If the network entity 405 identifies or otherwise determines that the QMC is known (e.g., stored or otherwise configured for the network entity 405), then the network entity 405 may request the UE 410 to report the QoE data (e.g., the QoE measurement results) for the QoE configuration (e.g., such as by providing or otherwise identifying a SRB4 configuration).

Accordingly and at 425, the network entity 405 may transmit or otherwise provide (and the UE 410 may receive or otherwise obtain) a bearer configuration for transmission of the set of QoE measurements. In some examples, the bearer configuration may identify or configure a SRB (e.g., SRB4) for transmission of the QoE measurement results (e.g., identify time resources, frequency resources, spatial resources, or code resources available for transmitting the QoE measurement results).

At 430, the UE 410 may transmit or otherwise provide (and the network entity 405 may receive or otherwise obtain) a subsequent QoE reporting message indicating the set of QoE measurements according to the bearer configuration. That is, the initial QoE reporting message (e.g., transmitted at 415) may indicate that the UE 410 has QoE measurement results for the MCE identifier. Network entity 405 may attempt to map the MCE identifier to a QMC and, if successful, configure bearer information for the UE 410 to use for transmitting the actual QoE measurement results to the network entity 405.

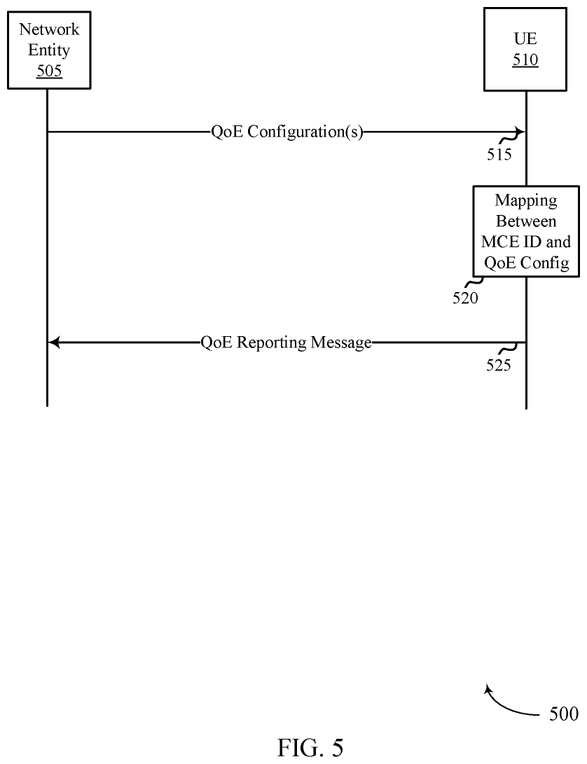

FIG. 5 illustrates an example of a method 500 that supports idle state QoE activation and reporting in accordance with one or more aspects of the present disclosure. Method 500 may implement aspects of wireless communication systems 100 or 200 or aspects of methods 300 or 400. Aspects of method 500 may be implemented at or implemented by the network entity 505 or the UE 510, which may be examples of the corresponding devices described herein.

As discussed above, aspects of the techniques described herein support improved QoE reporting techniques based on a MCE identifier included in the QoE reporting message. The NG-RAN may maintain, identify, or otherwise determine a mapping between the MCE identifier and the MCE or OAM associated with a QMC. The NG-RAN (e.g., the network entity 505) may map the MCE identifier in the QoE reporting message to the OAM or MCE and route the QoE report to the appropriate entity according to the mapping. Method 500 illustrates a non-limiting example where the UE 510 reports transmits the QoE reporting message when a QoE configuration corresponding to the set of QoE measurements is being provided by the network entity 505.

At 515, this may include the network entity 505 transmitting or otherwise providing (and the UE 510 receiving or otherwise obtaining) a QoE configuration for the set of QoE measurements. In this example, the network entity 505 may be an example of a serving cell of the UE 510. This may include the network entity 505 transmitting an indication of its configured QMC(s) to the UE located within its coverage area. For example, the indication of the QoE configuration may be provided in a multicast control channel (MCCH) message, in an RRC message, in a system information block (SIB), and the like. That is, the indication of the QoE configuration may be provided over an MCCH channel (e.g., using a MBSBroadcastConfiguration message), using dedicated RRC message (e.g., such as using RRCReconfiguration message), over a SIB, and the like. In some examples, each indicated QMC may include the MCE identifier.

At 520, the UE 510 may identify or otherwise that the MCE identifier is included in the QoE configuration received from the network entity 505. That is, the UE 510 may identify or otherwise determine whether its current cell is transmitting or otherwise providing an indication of one or more QMC(s) and, if so, whether the MCE identifier for the set of QoE measurements that the UE 510 has to report matches the MCE identifier in the indicated QMC(s). If the MCE identifier for the set of QoE measurements (e.g. the QoE measurement results) matches the MCE identifier then the UE 510 may report the QoE data to the NG-RAN.

Accordingly and at 525, the UE 510 may transmit or otherwise provide (and the network entity 505 may receive or otherwise obtain) a QoE reporting message including the MCE identifier as well as the indication of the set of QoE measurements. As discussed above, the indication of the set of QoE measurements may include the actual QoE measurement results or may include an indication that the QoE measurements are available for transmission. Accordingly, method 500 illustrates an example where the UE 510 reports buffered QoE measurement results for a QMC when its current cell indicates the QMC having the MCE identifier in its MCCH, RRC, or SIB message transmissions.

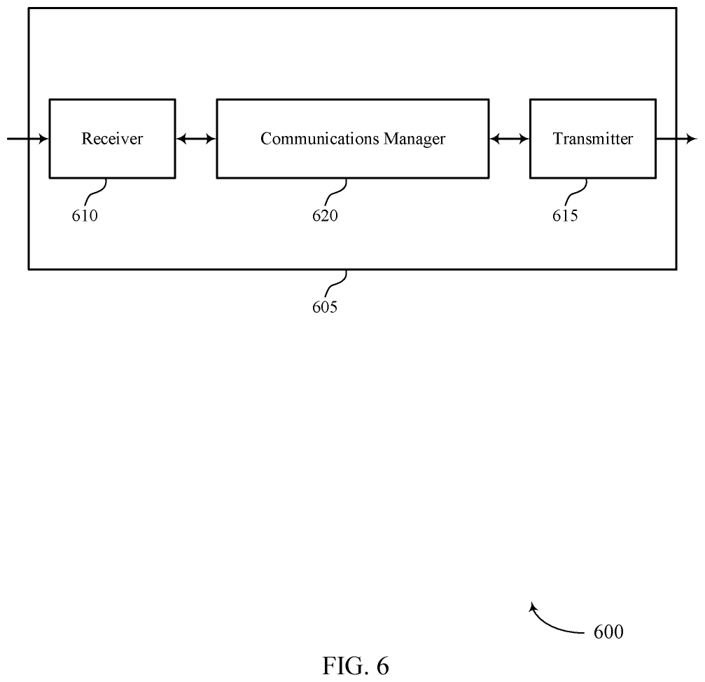

FIG. 6 shows a block diagram 600 of a device 605 that supports idle state QoE activation and reporting in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to idle state QoE activation and reporting). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to idle state QoE activation and reporting). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of idle state QoE activation and reporting as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving a control message indicating a QoE measurement activation for a set of QoE measurements by the UE, the control message indicating an application layer identifier associated with the QoE measurement activation. The communications manager 620 may be configured as or otherwise support a means for performing the set of QoE measurements in accordance with the QoE measurement activation. The communications manager 620 may be configured as or otherwise support a means for transmitting a QoE reporting message including a MCE identifier that corresponds to the application layer identifier and an indication of the set of QoE measurements.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for a UE to report buffered QoE measurement results using an MCE identifier in its QoE reporting message that maps back to the OAM or MCE associated with the QMC.

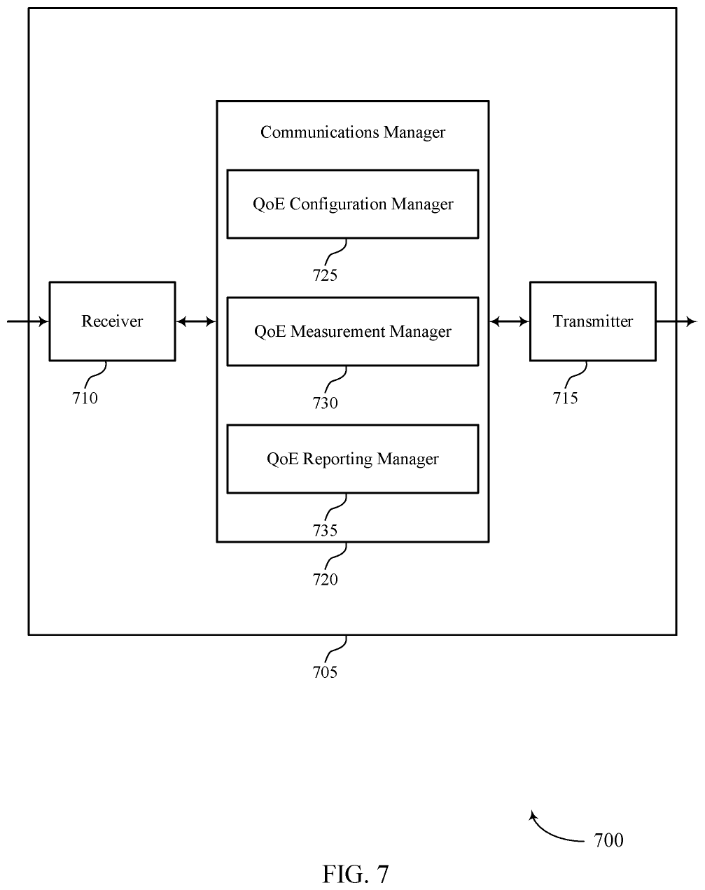

FIG. 7 shows a block diagram 700 of a device 705 that supports idle state QoE activation and reporting in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to idle state QoE activation and reporting). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to idle state QoE activation and reporting). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of idle state QoE activation and reporting as described herein. For example, the communications manager 720 may include a QoE configuration manager 725, a QoE measurement manager 730, a QoE reporting manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The QoE configuration manager 725 may be configured as or otherwise support a means for receiving a control message indicating a QoE measurement activation for a set of QoE measurements by the UE, the control message indicating an application layer identifier associated with the QoE measurement activation. The QoE measurement manager 730 may be configured as or otherwise support a means for performing the set of QoE measurements in accordance with the QoE measurement activation. The QoE reporting manager 735 may be configured as or otherwise support a means for transmitting a QoE reporting message including a MCE identifier that corresponds to the application layer identifier and an indication of the set of QoE measurements.

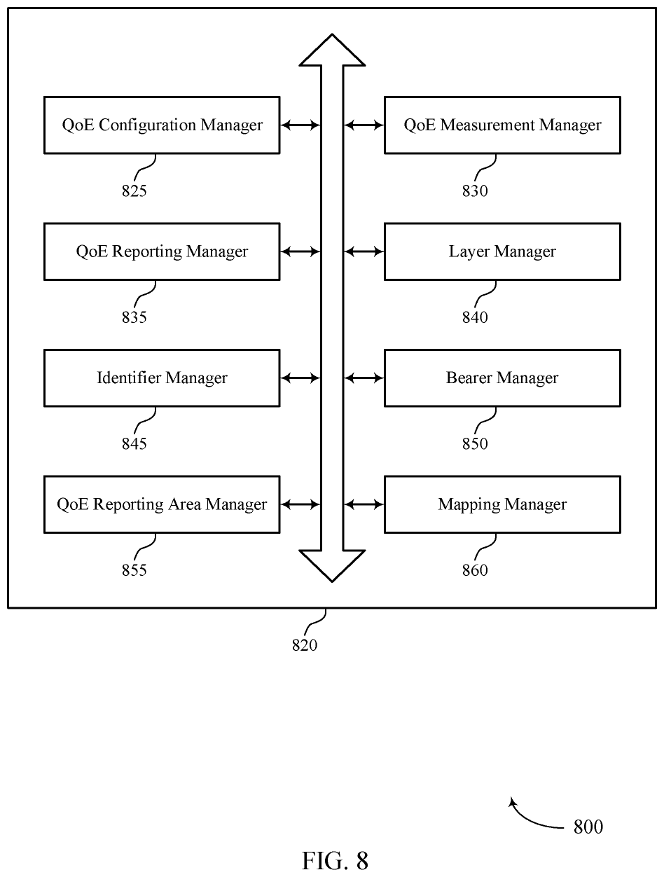

FIG. 8 shows a block diagram 800 of a communications manager 820 that supports idle state QoE activation and reporting in accordance with one or more aspects of the present disclosure. The communications manager 820 may be an example of aspects of a communications manager 620, a communications manager 720, or both, as described herein. The communications manager 820, or various components thereof, may be an example of means for performing various aspects of idle state QoE activation and reporting as described herein. For example, the communications manager 820 may include a QoE configuration manager 825, a QoE measurement manager 830, a QoE reporting manager 835, a layer manager 840, an identifier manager 845, a bearer manager 850, a QoE reporting area manager 855, a mapping manager 860, or any combination thereof. Each of these components may communicate, directly or indirectly, with one another (e.g., via one or more buses).

The communications manager 820 may support wireless communication at a UE in accordance with examples as disclosed herein. The QoE configuration manager 825 may be configured as or otherwise support a means for receiving a control message indicating a QoE measurement activation for a set of QoE measurements by the UE, the control message indicating an application layer identifier associated with the QoE measurement activation. The QoE measurement manager 830 may be configured as or otherwise support a means for performing the set of QoE measurements in accordance with the QoE measurement activation. The QoE reporting manager 835 may be configured as or otherwise support a means for transmitting a QoE reporting message including a MCE identifier that corresponds to the application layer identifier and an indication of the set of QoE measurements.

In some examples, the layer manager 840 may be configured as or otherwise support a means for obtaining, at an access layer of the UE, an indication of the MCE identifier from an application layer of the UE. In some examples, the layer manager 840 may be configured as or otherwise support a means for including, by the access layer, the MCE identifier in the QoE reporting message based on the indication of the MCE identifier obtained from the application layer.

In some examples, the layer manager 840 may be configured as or otherwise support a means for identifying, at the access layer, a mapping of the MCE identifier to the set of QoE measurements based on the control message, where the MCE identifier is included in the QoE reporting message based on the mapping.

In some examples, the identifier manager 845 may be configured as or otherwise support a means for identifying, at an access layer of the UE, a mapping of a unique identifier to the MCE identifier based on the control message. In some examples, the identifier manager 845 may be configured as or otherwise support a means for providing, by the access layer, an indication of the QoE measurement activation and the unique identifier to an application layer of the UE. In some examples, the identifier manager 845 may be configured as or otherwise support a means for obtaining, from the application layer, an indication of the set of QoE measurements and the unique identifier. In some examples, the identifier manager 845 may be configured as or otherwise support a means for including, by the access layer, the MCE identifier in the QoE reporting message based on the indication of the unique identifier obtained from the application layer.

In some examples, the bearer manager 850 may be configured as or otherwise support a means for including, at an access layer of the UE, an indication that the set of QoE measurements are available for transmission in the QoE reporting message. In some examples, the bearer manager 850 may be configured as or otherwise support a means for receiving a bearer configuration for transmission of the set of QoE measurements based on the indication that the set of QoE measurements are available. In some examples, the bearer manager 850 may be configured as or otherwise support a means for transmitting a subsequent QoE reporting message indicating the set of QoE measurements based on the bearer configuration.

In some examples, the bearer manager 850 may be configured as or otherwise support a means for obtaining, at the access layer, the set of QoE measurements from an application layer of the UE, where the indication that the set of QoE measurements are available is based on the obtaining. In some examples, the bearer manager 850 may be configured as or otherwise support a means for obtaining, at the access layer, the indication that the set of QoE measurements are available from an application layer of the UE, where the indication that the set of QoE measurements are available is based on the obtaining.

In some examples, the QoE reporting area manager 855 may be configured as or otherwise support a means for identifying a QoE reporting area for the set of QoE measurements based on the QoE measurement activation, the QoE reporting area being different from or the same as a QoE measurement area for the QoE measurement activation. In some examples, the QoE reporting area manager 855 may be configured as or otherwise support a means for determining that the UE is located within the QoE reporting area, where the QoE reporting message is transmitted based at least part on the UE being located within the QoE reporting area.

In some examples, the QoE reporting area manager 855 may be configured as or otherwise support a means for identifying the QoE reporting area at an application layer of the UE and based on at least one of the QoE measurement activation or an indication obtained from an access layer of the UE. In some examples, the QoE reporting area manager 855 may be configured as or otherwise support a means for identifying the QoE reporting area at an access layer of the UE and based on an indication of the QoE reporting area received via radio resource signaling.

In some examples, the mapping manager 860 may be configured as or otherwise support a means for receiving a QoE configuration for the set of QoE measurements from a serving cell of the UE. In some examples, the mapping manager 860 may be configured as or otherwise support a means for determining that the MCE identifier is included in the QoE configuration, where the QoE reporting message is transmitted based on the MCE identifier being included in the QoE configuration. In some examples, the QoE configuration is received in at least one a MCCH message, an RRC message, an SIB message, or a combination thereof, from the serving cell. In some examples, the MCE identifier includes at least one of an address, identifying information, a reference, a QoE server name, or a combination thereof, for an MCE associated with the QoE measurement activation.

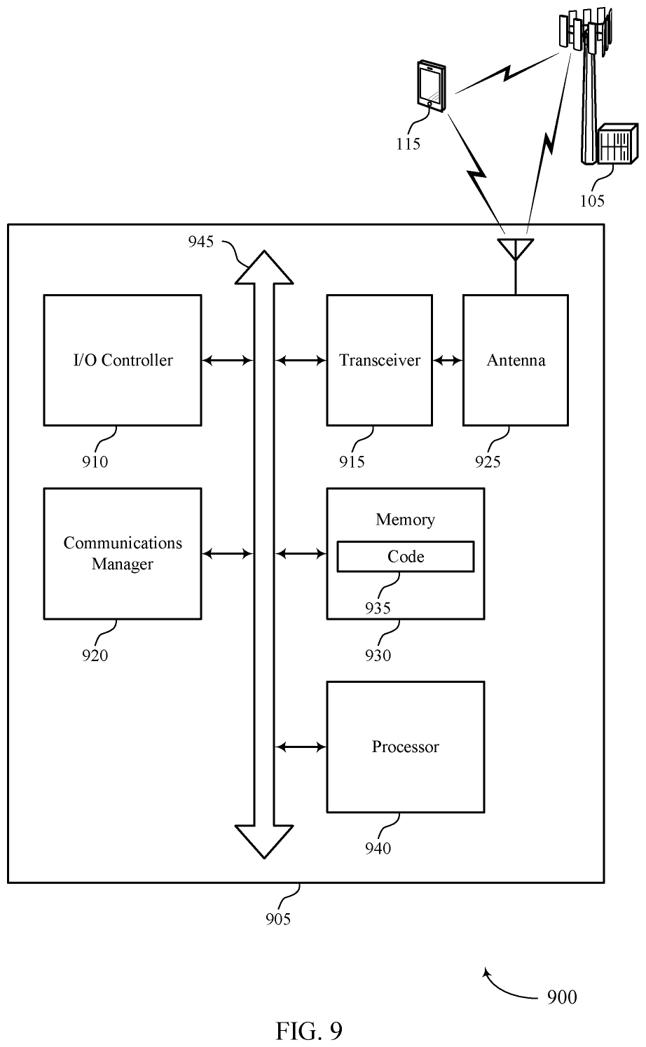

FIG. 9 shows a diagram of a system 900 including a device 905 that supports idle state QoE activation and reporting in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting idle state QoE activation and reporting). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving a control message indicating a QoE measurement activation for a set of QoE measurements by the UE, the control message indicating an application layer identifier associated with the QoE measurement activation. The communications manager 920 may be configured as or otherwise support a means for performing the set of QoE measurements in accordance with the QoE measurement activation. The communications manager 920 may be configured as or otherwise support a means for transmitting a QoE reporting message including a MCE identifier that corresponds to the application layer identifier and an indication of the set of QoE measurements.

By including or configuring the communications manager 920 in accordance with examples as described herein, the device 905 may support techniques for a UE to report buffered QoE measurement results using an MCE identifier in its QoE reporting message that maps back to the OAM or MCE associated with the QMC.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of idle state QoE activation and reporting as described herein, or the processor 940 and the memory 930 may be otherwise configured to perform or support such operations.

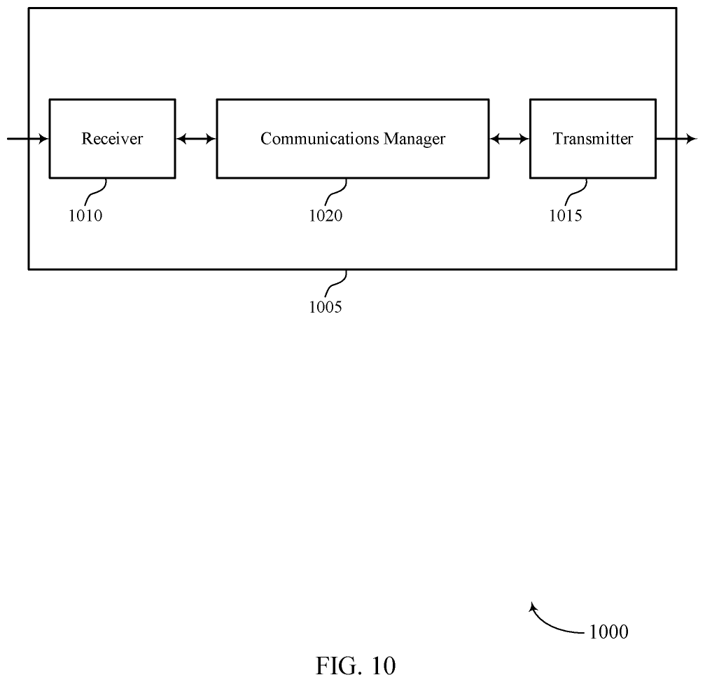

FIG. 10 shows a block diagram 1000 of a device 1005 that supports idle state QoE activation and reporting in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of idle state QoE activation and reporting as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for transmitting, to a UE, a control message indicating a QoE measurement activation for a set of QoE measurements by the UE, the control message indicating an application layer identifier associated with the QoE measurement activation. The communications manager 1020 may be configured as or otherwise support a means for receiving, from the UE and based on the QoE measurement activation, a QoE reporting message including a MCE identifier that corresponds to the application layer identifier and an indication of the set of QoE measurements.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for a UE to report buffered QoE measurement results using an MCE identifier in its QoE reporting message that maps back to the OAM or MCE associated with the QMC.

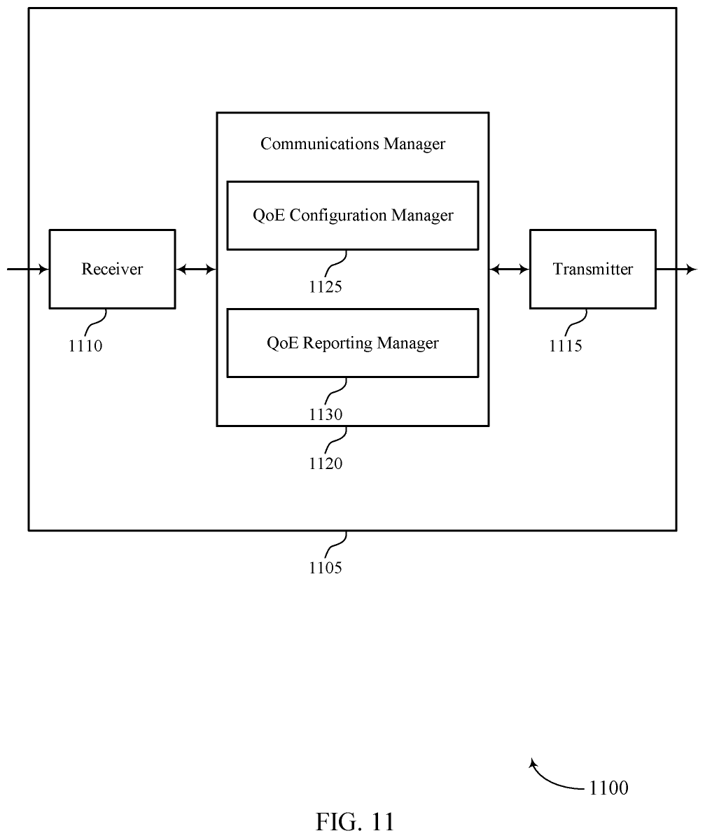

FIG. 11 shows a block diagram 1100 of a device 1105 that supports idle state QoE activation and reporting in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of idle state QoE activation and reporting as described herein. For example, the communications manager 1120 may include a QoE configuration manager 1125 a QoE reporting manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The QoE configuration manager 1125 may be configured as or otherwise support a means for transmitting, to a UE, a control message indicating a QoE measurement activation for a set of QoE measurements by the UE, the control message indicating an application layer identifier associated with the QoE measurement activation. The QoE reporting manager 1130 may be configured as or otherwise support a means for receiving, from the UE and based on the QoE measurement activation, a QoE reporting message including a MCE identifier that corresponds to the application layer identifier and an indication of the set of QoE measurements.

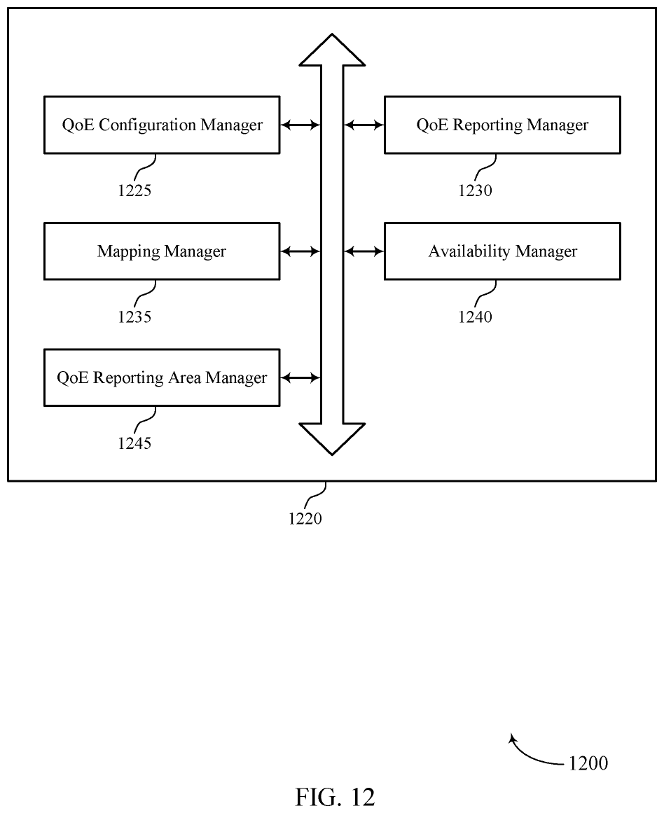

FIG. 12 shows a block diagram 1200 of a communications manager 1220 that supports idle state QoE activation and reporting in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of idle state QoE activation and reporting as described herein. For example, the communications manager 1220 may include a QoE configuration manager 1225, a QoE reporting manager 1230, a mapping manager 1235, an availability manager 1240, a QoE reporting area manager 1245, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The QoE configuration manager 1225 may be configured as or otherwise support a means for transmitting, to a UE, a control message indicating a QoE measurement activation for a set of QoE measurements by the UE, the control message indicating an application layer identifier associated with the QoE measurement activation. The QoE reporting manager 1230 may be configured as or otherwise support a means for receiving, from the UE and based on the QoE measurement activation, a QoE reporting message including a MCE identifier that corresponds to the application layer identifier and an indication of the set of QoE measurements.

In some examples, the mapping manager 1235 may be configured as or otherwise support a means for mapping the MCE identifier to the set of QoE measurements, where the control message indicates the mapping. In some examples, the indication of the set of QoE measurements includes the set of QoE measurements.

In some examples, the availability manager 1240 may be configured as or otherwise support a means for identifying an indication that the set of QoE measurements are available for transmission based on the QoE reporting message. In some examples, the availability manager 1240 may be configured as or otherwise support a means for transmitting a bearer configuration for transmission of the set of QoE measurements based on the indication that the set of QoE measurements are available. In some examples, the availability manager 1240 may be configured as or otherwise support a means for receiving a subsequent QoE reporting message indicating the set of QoE measurements.

In some examples, the QoE reporting area manager 1245 may be configured as or otherwise support a means for indicating a QoE reporting area for the set of QoE measurements based on the QoE measurement activation, the QoE reporting area being different from or the same as a QoE measurement area for the QoE measurement activation. In some examples, the QoE reporting area manager 1245 may be configured as or otherwise support a means for receiving the QoE reporting message based on the UE being located within the QoE reporting area.

In some examples, the mapping manager 1235 may be configured as or otherwise support a means for transmitting a QoE configuration including the MCE identifier for the set of QoE measurements, where the QoE reporting message is received based on the MCE identifier being included in the QoE configuration. In some examples, the QoE configuration is transmitted in at least one a MCCH message, an RRC message, an SIB message, or a combination thereof, from the network entity. In some examples, the MCE identifier includes at least one of an address, identifying information, a reference, a QoE server name, or a combination thereof, for an MCE associated with the QoE measurement activation.

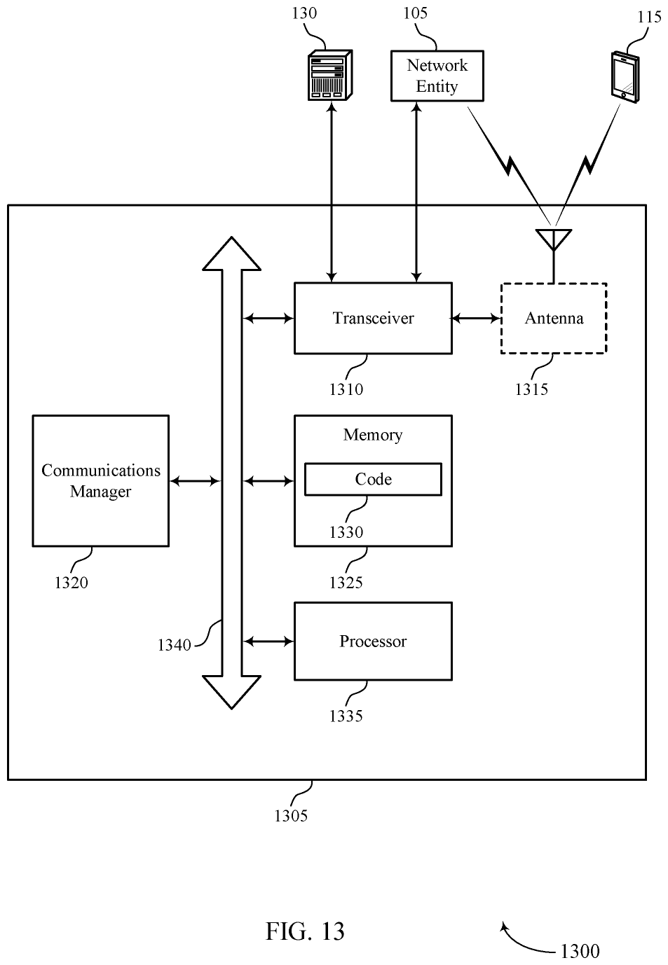

FIG. 13 shows a diagram of a system 1300 including a device 1305 that supports idle state QoE activation and reporting in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting idle state QoE activation and reporting). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for transmitting, to a UE, a control message indicating a QoE measurement activation for a set of QoE measurements by the UE, the control message indicating an application layer identifier associated with the QoE measurement activation. The communications manager 1320 may be configured as or otherwise support a means for receiving, from the UE and based on the QoE measurement activation, a QoE reporting message including a MCE identifier that corresponds to the application layer identifier and an indication of the set of QoE measurements.

By including or configuring the communications manager 1320 in accordance with examples as described herein, the device 1305 may support techniques for a UE to report buffered QoE measurement results using an MCE identifier in its QoE reporting message that maps back to the OAM or MCE associated with the QMC.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of idle state QoE activation and reporting as described herein, or the processor 1335 and the memory 1325 may be otherwise configured to perform or support such operations.

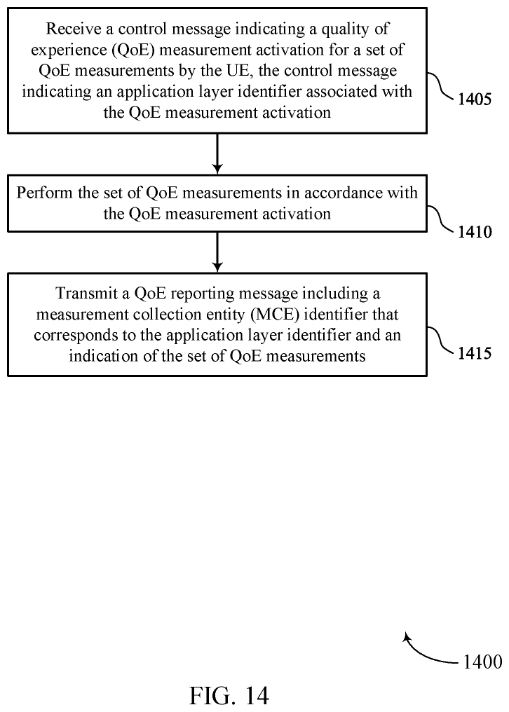

FIG. 14 shows a flowchart illustrating a method 1400 that supports idle state QoE activation and reporting in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a control message indicating a QoE measurement activation for a set of QoE measurements by the UE, the control message indicating an application layer identifier associated with the QoE measurement activation. The operations of 1405 may be performed in accordance with examples as disclosed herein. In some examples, aspects of the operations of 1405 may be performed by a QoE configuration manager 825 as described with reference to FIG. 8.

At 1410, the method may include performing the set of QoE measurements in accordance with the QoE measurement activation. The operations of 1410 may be performed in accordance with examples as disclosed herein. In some examples, aspects of the operations of 1410 may be performed by a QoE measurement manager 830 as described with reference to FIG. 8.

At 1415, the method may include transmitting a QoE reporting message including a MCE identifier that corresponds to the application layer identifier and an indication of the set of QoE measurements. The operations of 1415 may be performed in accordance with examples as disclosed herein. In some examples, aspects of the operations of 1415 may be performed by a QoE reporting manager 835 as described with reference to FIG. 8.

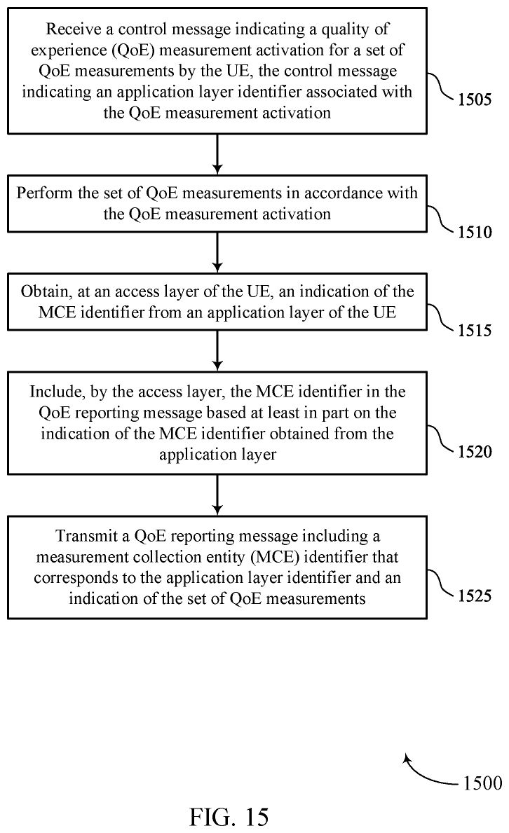

FIG. 15 shows a flowchart illustrating a method 1500 that supports idle state QoE activation and reporting in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a control message indicating a QoE measurement activation for a set of QoE measurements by the UE, the control message indicating an application layer identifier associated with the QoE measurement activation. The operations of 1505 may be performed in accordance with examples as disclosed herein. In some examples, aspects of the operations of 1505 may be performed by a QoE configuration manager 825 as described with reference to FIG. 8.

At 1510, the method may include performing the set of QoE measurements in accordance with the QoE measurement activation. The operations of 1510 may be performed in accordance with examples as disclosed herein. In some examples, aspects of the operations of 1510 may be performed by a QoE measurement manager 830 as described with reference to FIG. 8.

At 1515, the method may include obtaining, at an access layer of the UE, an indication of the MCE identifier from an application layer of the UE. The operations of 1515 may be performed in accordance with examples as disclosed herein. In some examples, aspects of the operations of 1515 may be performed by a layer manager 840 as described with reference to FIG. 8.

At 1520, the method may include including, by the access layer, the MCE identifier in the QoE reporting message based on the indication of the MCE identifier obtained from the application layer. The operations of 1520 may be performed in accordance with examples as disclosed herein. In some examples, aspects of the operations of 1520 may be performed by a layer manager 840 as described with reference to FIG. 8.

At 1525, the method may include transmitting a QoE reporting message including a MCE identifier that corresponds to the application layer identifier and an indication of the set of QoE measurements. The operations of 1525 may be performed in accordance with examples as disclosed herein. In some examples, aspects of the operations of 1525 may be performed by a QoE reporting manager 835 as described with reference to FIG. 8.

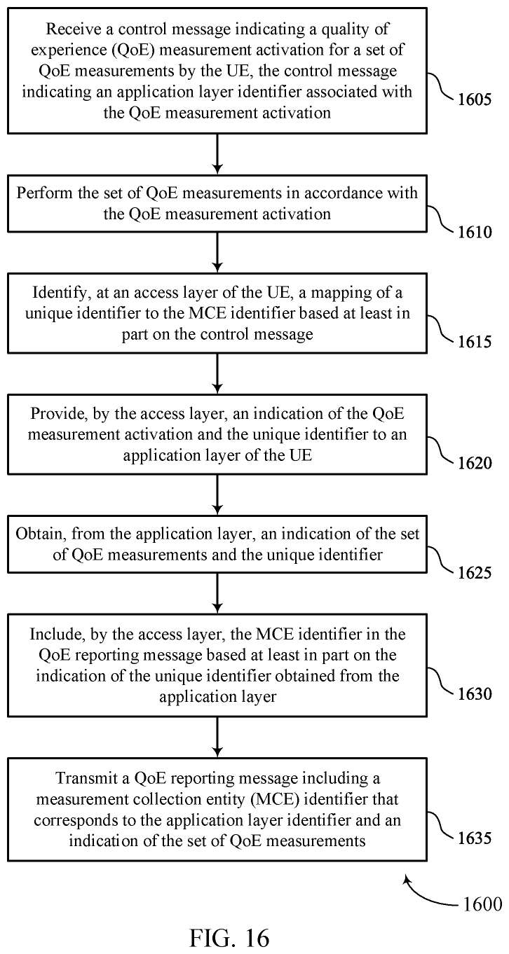

FIG. 16 shows a flowchart illustrating a method 1600 that supports idle state QoE activation and reporting in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving a control message indicating a QoE measurement activation for a set of QoE measurements by the UE, the control message indicating an application layer identifier associated with the QoE measurement activation. The operations of 1605 may be performed in accordance with examples as disclosed herein. In some examples, aspects of the operations of 1605 may be performed by a QoE configuration manager 825 as described with reference to FIG. 8.

At 1610, the method may include performing the set of QoE measurements in accordance with the QoE measurement activation. The operations of 1610 may be performed in accordance with examples as disclosed herein. In some examples, aspects of the operations of 1610 may be performed by a QoE measurement manager 830 as described with reference to FIG. 8.

At 1615, the method may include identifying, at an access layer of the UE, a mapping of a unique identifier to the MCE identifier based on the control message. The operations of 1615 may be performed in accordance with examples as disclosed herein. In some examples, aspects of the operations of 1615 may be performed by an identifier manager 845 as described with reference to FIG. 8.

At 1620, the method may include providing, by the access layer, an indication of the QoE measurement activation and the unique identifier to an application layer of the UE. The operations of 1620 may be performed in accordance with examples as disclosed herein. In some examples, aspects of the operations of 1620 may be performed by an identifier manager 845 as described with reference to FIG. 8.

At 1625, the method may include obtaining, from the application layer, an indication of the set of QoE measurements and the unique identifier. The operations of 1625 may be performed in accordance with examples as disclosed herein. In some examples, aspects of the operations of 1625 may be performed by an identifier manager 845 as described with reference to FIG. 8.

At 1630, the method may include including, by the access layer, the MCE identifier in the QoE reporting message based on the indication of the unique identifier obtained from the application layer. The operations of 1630 may be performed in accordance with examples as disclosed herein. In some examples, aspects of the operations of 1630 may be performed by an identifier manager 845 as described with reference to FIG. 8.

At 1635, the method may include transmitting a QoE reporting message including a MCE identifier that corresponds to the application layer identifier and an indication of the set of QoE measurements. The operations of 1635 may be performed in accordance with examples as disclosed herein. In some examples, aspects of the operations of 1635 may be performed by a QoE reporting manager 835 as described with reference to FIG. 8.

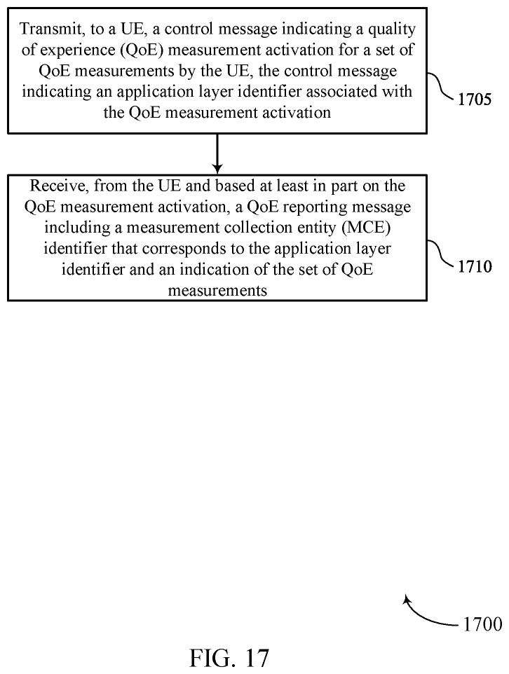

FIG. 17 shows a flowchart illustrating a method 1700 that supports idle state QoE activation and reporting in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, a control message indicating a QoE measurement activation for a set of QoE measurements by the UE, the control message indicating an application layer identifier associated with the QoE measurement activation. The operations of 1705 may be performed in accordance with examples as disclosed herein. In some examples, aspects of the operations of 1705 may be performed by a QoE configuration manager 1225 as described with reference to FIG. 12.

At 1710, the method may include receiving, from the UE and based on the QoE measurement activation, a QoE reporting message including a MCE identifier that corresponds to the application layer identifier and an indication of the set of QoE measurements. The operations of 1710 may be performed in accordance with examples as disclosed herein. In some examples, aspects of the operations of 1710 may be performed by a QoE reporting manager 1230 as described with reference to FIG. 12.

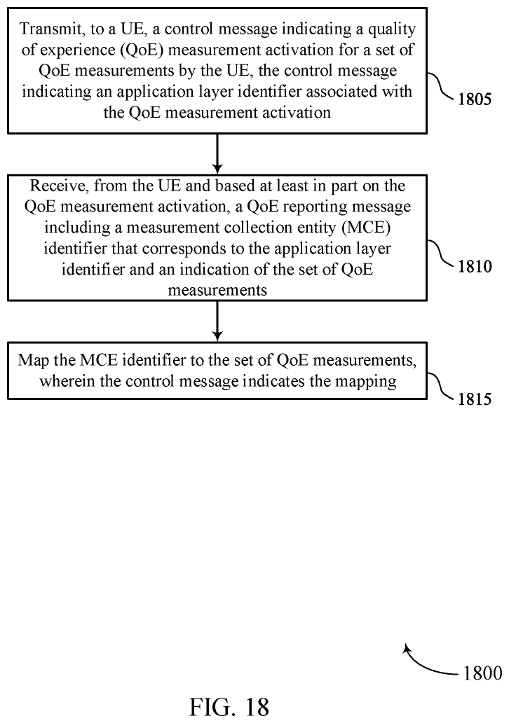

FIG. 18 shows a flowchart illustrating a method 1800 that supports idle state QoE activation and reporting in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a UE, a control message indicating a QoE measurement activation for a set of QoE measurements by the UE, the control message indicating an application layer identifier associated with the QoE measurement activation. The operations of 1805 may be performed in accordance with examples as disclosed herein. In some examples, aspects of the operations of 1805 may be performed by a QoE configuration manager 1225 as described with reference to FIG. 12.

At 1810, the method may include receiving, from the UE and based on the QoE measurement activation, a QoE reporting message including a MCE identifier that corresponds to the application layer identifier and an indication of the set of QoE measurements. The operations of 1810 may be performed in accordance with examples as disclosed herein. In some examples, aspects of the operations of 1810 may be performed by a QoE reporting manager 1230 as described with reference to FIG. 12.

At 1815, the method may include mapping the MCE identifier to the set of QoE measurements, where the control message indicates the mapping. The operations of 1815 may be performed in accordance with examples as disclosed herein. In some examples, aspects of the operations of 1815 may be performed by a mapping manager 1235 as described with reference to FIG. 12.

The following provides an overview of aspects of the present disclosure:

Aspect 1: A method for wireless communication at a UE, comprising: receiving a control message indicating a QoE measurement activation for a set of QoE measurements by the UE, the control message indicating an application layer identifier associated with the QoE measurement activation; performing the set of QoE measurements in accordance with the QoE measurement activation; and transmitting a QoE reporting message including a MCE identifier that corresponds to the application layer identifier and an indication of the set of QoE measurements.

Aspect 2: The method of aspect 1, further comprising: obtaining, at an access layer of the UE, an indication of the MCE identifier from an application layer of the UE; and including, by the access layer, the MCE identifier in the QoE reporting message based at least in part on the indication of the MCE identifier obtained from the application layer.

Aspect 3: The method of aspect 2, further comprising: identifying, at the access layer, a mapping of the MCE identifier to the set of QoE measurements based at least in part on the control message, wherein the MCE identifier is included in the QoE reporting message based at least in part on the mapping.

Aspect 4: The method of any of aspects 1 through 3, further comprising: identifying, at an access layer of the UE, a mapping of a unique identifier to the MCE identifier based at least in part on the control message; providing, by the access layer, an indication of the QoE measurement activation and the unique identifier to an application layer of the UE; obtaining, from the application layer, an indication of the set of QoE measurements and the unique identifier; and including, by the access layer, the MCE identifier in the QoE reporting message based at least in part on the indication of the unique identifier obtained from the application layer.

Aspect 5: The method of any of aspects 1 through 4, further comprising: including, at an access layer of the UE, an indication that the set of QoE measurements are available for transmission in the QoE reporting message; receiving a bearer configuration for transmission of the set of QoE measurements based at least in part on the indication that the set of QoE measurements are available; and transmitting a subsequent QoE reporting message indicating the set of QoE measurements based at least in part on the bearer configuration.

Aspect 6: The method of aspect 5, further comprising: obtaining, at the access layer, the set of QoE measurements from an application layer of the UE, wherein the indication that the set of QoE measurements are available is based at least in part on the obtaining.

Aspect 7: The method of any of aspects 5 through 6, further comprising: obtaining, at the access layer, the indication that the set of QoE measurements are available from an application layer of the UE, wherein the indication that the set of QoE measurements are available is based at least in part on the obtaining.

Aspect 8: The method of any of aspects 1 through 7, further comprising: identifying a QoE reporting area for the set of QoE measurements based at least in part on the QoE measurement activation, the QoE reporting area being different from or the same as a QoE measurement area for the QoE measurement activation; and determining that the UE is located within the QoE reporting area, wherein the QoE reporting message is transmitted based at least part on the UE being located within the QoE reporting area.

Aspect 9: The method of aspect 8, further comprising: identifying the QoE reporting area at an application layer of the UE and based on at least one of the QoE measurement activation or an indication obtained from an access layer of the UE.

Aspect 10: The method of any of aspects 8 through 9, further comprising: identifying the QoE reporting area at an access layer of the UE and based at least in part on an indication of the QoE reporting area received via radio resource signaling.

Aspect 11: The method of any of aspects 1 through 10, further comprising: receiving a QoE configuration for the set of QoE measurements from a serving cell of the UE; and determining that the MCE identifier is included in the QoE configuration, wherein the QoE reporting message is transmitted based at least in part on the MCE identifier being included in the QoE configuration.

Aspect 12: The method of aspect 11, wherein the QoE configuration is received in at least one a MCCH message, an RRC message, an SIB message, or a combination thereof, from the serving cell.

Aspect 13: The method of any of aspects 1 through 12, wherein the MCE identifier comprises at least one of an address, identifying information, a reference, a QoE server name, or a combination thereof, for an MCE associated with the QoE measurement activation.

Aspect 14: A method for wireless communication at a network entity, comprising: transmitting, to a UE, a control message indicating a QoE measurement activation for a set of QoE measurements by the UE, the control message indicating an application layer identifier associated with the QoE measurement activation; and receiving, from the UE and based at least in part on the QoE measurement activation, a QoE reporting message including a MCE identifier that corresponds to the application layer identifier and an indication of the set of QoE measurements.

Aspect 15: The method of aspect 14, further comprising: mapping the MCE identifier to the set of QoE measurements, wherein the control message indicates the mapping.

Aspect 16: The method of any of aspects 14 through 15, wherein the indication of the set of QoE measurements comprises the set of QoE measurements.

Aspect 17: The method of any of aspects 14 through 16, further comprising: identifying an indication that the set of QoE measurements are available for transmission based at least in part on the QoE reporting message; transmitting a bearer configuration for transmission of the set of QoE measurements based at least in part on the indication that the set of QoE measurements are available; and receiving a subsequent QoE reporting message indicating the set of QoE measurements.

Aspect 18: The method of any of aspects 14 through 17, further comprising: indicating a QoE reporting area for the set of QoE measurements based at least in part on the QoE measurement activation, the QoE reporting area being different from or the same as a QoE measurement area for the QoE measurement activation; and receiving the QoE reporting message based at least in part on the UE being located within the QoE reporting area.

Aspect 19: The method of any of aspects 14 through 18, further comprising: transmitting a QoE configuration including the MCE identifier for the set of QoE measurements, wherein the QoE reporting message is received based at least in part on the MCE identifier being included in the QoE configuration.

Aspect 20: The method of aspect 19, wherein the QoE configuration is transmitted in at least one a MCCH message, an RRC message, an SIB message, or a combination thereof, from the network entity.

Aspect 21: The method of any of aspects 14 through 20, wherein the MCE identifier comprises at least one of an address, identifying information, a reference, a QoE server name, or a combination thereof, for an MCE associated with the QoE measurement activation.

Aspect 22: An apparatus for wireless communication at a UE, comprising a processor; memory coupled with the processor; and instructions stored in the memory and executable by the processor to cause the apparatus to perform a method of any of aspects 1 through 13.

Aspect 23: An apparatus for wireless communication at a UE, comprising at least one means for performing a method of any of aspects 1 through 13.

Aspect 24: A non-transitory computer-readable medium storing code for wireless communication at a UE, the code comprising instructions executable by a processor to perform a method of any of aspects 1 through 13.

Aspect 25: An apparatus for wireless communication at a network entity, comprising a processor; memory coupled with the processor; and instructions stored in the memory and executable by the processor to cause the apparatus to perform a method of any of aspects 14 through 21.

Aspect 26: An apparatus for wireless communication at a network entity, comprising at least one means for performing a method of any of aspects 14 through 21.

Aspect 27: A non-transitory computer-readable medium storing code for wireless communication at a network entity, the code comprising instructions executable by a processor to perform a method of any of aspects 14 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive a control message indicating a quality of experience (QoE) measurement activation for a set of QoE measurements by the UE, the control message indicating an application layer identifier associated with the QoE measurement activation;
perform the set of QoE measurements in accordance with the QoE measurement activation; and
transmit a QoE reporting message including a measurement collection entity (MCE) identifier that corresponds to the application layer identifier and an indication of the set of QoE measurements.

2. The apparatus of claim 1, wherein the instructions are further executable by the processor to cause the apparatus to:
obtain, at an access layer of the UE, an indication of the MCE identifier from an application layer of the UE; and
include, by the access layer, the MCE identifier in the QoE reporting message based at least in part on the indication of the MCE identifier obtained from the application layer.

3. The apparatus of claim 2, wherein the instructions are further executable by the processor to cause the apparatus to:
identify, at the access layer, a mapping of the MCE identifier to the set of QoE measurements based at least in part on the control message, wherein the MCE identifier is included in the QoE reporting message based at least in part on the mapping.

4. The apparatus of claim 1, wherein the instructions are further executable by the processor to cause the apparatus to:
identify, at an access layer of the UE, a mapping of a unique identifier to the MCE identifier based at least in part on the control message;
provide, by the access layer, an indication of the QoE measurement activation and the unique identifier to an application layer of the UE;
obtain, from the application layer, an indication of the set of QoE measurements and the unique identifier; and
include, by the access layer, the MCE identifier in the QoE reporting message based at least in part on the indication of the unique identifier obtained from the application layer.

5. The apparatus of claim 1, wherein the instructions are further executable by the processor to cause the apparatus to:
include, at an access layer of the UE, an indication that the set of QoE measurements are available for transmission in the QoE reporting message;
receive a bearer configuration for transmission of the set of QoE measurements based at least in part on the indication that the set of QoE measurements are available; and
transmit a subsequent QoE reporting message indicating the set of QoE measurements based at least in part on the bearer configuration.

6. The apparatus of claim 5, wherein the instructions are further executable by the processor to cause the apparatus to:
obtain, at the access layer, the set of QoE measurements from an application layer of the UE, wherein the indication that the set of QoE measurements are available is based at least in part on the obtaining.

7. The apparatus of claim 5, wherein the instructions are further executable by the processor to cause the apparatus to:
obtain, at the access layer, the indication that the set of QoE measurements are available from an application layer of the UE, wherein the indication that the set of QoE measurements are available is based at least in part on the obtaining.

8. The apparatus of claim 1, wherein the instructions are further executable by the processor to cause the apparatus to:
identify a QoE reporting area for the set of QoE measurements based at least in part on the QoE measurement activation, the QoE reporting area being different from or the same as a QoE measurement area for the QoE measurement activation; and
determine that the UE is located within the QoE reporting area, wherein the QoE reporting message is transmitted based at least part on the UE being located within the QoE reporting area.

9. The apparatus of claim 8, wherein the instructions are further executable by the processor to cause the apparatus to:
identify the QoE reporting area at an application layer of the UE and based on at least one of the QoE measurement activation or an indication obtained from an access layer of the UE.

10. The apparatus of claim 8, wherein the instructions are further executable by the processor to cause the apparatus to:
identify the QoE reporting area at an access layer of the UE and based at least in part on an indication of the QoE reporting area received via radio resource signaling.

11. The apparatus of claim 1, wherein the instructions are further executable by the processor to cause the apparatus to:
receive a QoE configuration for the set of QoE measurements from a serving cell of the UE; and
determine that the MCE identifier is included in the QoE configuration, wherein the QoE reporting message is transmitted based at least in part on the MCE identifier being included in the QoE configuration.

12. The apparatus of claim 11, wherein the QoE configuration is received in at least one a multicast control channel (MCCH) message, a radio resource control (RRC) message, a system information block (SIB) message, or a combination thereof, from the serving cell.

13. The apparatus of claim 1, wherein the MCE identifier comprises at least one of an address, identifying information, a reference, a QoE server name, or a combination thereof, for an MCE associated with the QoE measurement activation.

14. An apparatus for wireless communication at a network entity, comprising:
a processor;
memory coupled with the processor; and
instructions stored in the memory and executable by the processor to cause the apparatus to:
transmit, to a user equipment (UE), a control message indicating a quality of experience (QoE) measurement activation for a set of QoE measurements by the UE, the control message indicating an application layer identifier associated with the QoE measurement activation; and
receive, from the UE and based at least in part on the QoE measurement activation, a QoE reporting message including a measurement collection entity (MCE) identifier that corresponds to the application layer identifier and an indication of the set of QoE measurements.

15. The apparatus of claim 14, wherein the instructions are further executable by the processor to cause the apparatus to:
map the MCE identifier to the set of QoE measurements, wherein the control message indicates the mapping.

16. The apparatus of claim 14, wherein the indication of the set of QoE measurements comprises the set of QoE measurements.

17. The apparatus of claim 14, wherein the instructions are further executable by the processor to cause the apparatus to:
identify an indication that the set of QoE measurements are available for transmission based at least in part on the QoE reporting message;
transmit a bearer configuration for transmission of the set of QoE measurements based at least in part on the indication that the set of QoE measurements are available; and
receive a subsequent QoE reporting message indicating the set of QoE measurements.

18. The apparatus of claim 14, wherein the instructions are further executable by the processor to cause the apparatus to:
indicate a QoE reporting area for the set of QoE measurements based at least in part on the QoE measurement activation, the QoE reporting area being different from or the same as a QoE measurement area for the QoE measurement activation; and
receive the QoE reporting message based at least in part on the UE being located within the QoE reporting area.

19. The apparatus of claim 14, wherein the instructions are further executable by the processor to cause the apparatus to:
transmit a QoE configuration including the MCE identifier for the set of QoE measurements, wherein the QoE reporting message is received based at least in part on the MCE identifier being included in the QoE configuration.

20. The apparatus of claim 19, wherein the QoE configuration is transmitted in at least one a multicast control channel (MCCH) message, a radio resource control (RRC) message, a system information block (SIB) message, or a combination thereof, from the network entity.

21. The apparatus of claim 14, wherein the MCE identifier comprises at least one of an address, identifying information, a reference, a QoE server name, or a combination thereof, for an MCE associated with the QoE measurement activation.

22. A method for wireless communication at a user equipment (UE), comprising:
receiving a control message indicating a quality of experience (QoE) measurement activation for a set of QoE measurements by the UE, the control message indicating an application layer identifier associated with the QoE measurement activation;
performing the set of QoE measurements in accordance with the QoE measurement activation; and
transmitting a QoE reporting message including a measurement collection entity (MCE) identifier that corresponds to the application layer identifier and an indication of the set of QoE measurements.

23. The method of claim 22, further comprising:
obtaining, at an access layer of the UE, an indication of the MCE identifier from an application layer of the UE; and
including, by the access layer, the MCE identifier in the QoE reporting message based at least in part on the indication of the MCE identifier obtained from the application layer.

24. The method of claim 23, further comprising:
identifying, at the access layer, a mapping of the MCE identifier to the set of QoE measurements based at least in part on the control message, wherein the MCE identifier is included in the QoE reporting message based at least in part on the mapping.

25. The method of claim 22, further comprising:
identifying, at an access layer of the UE, a mapping of a unique identifier to the MCE identifier based at least in part on the control message;
providing, by the access layer, an indication of the QoE measurement activation and the unique identifier to an application layer of the UE;
obtaining, from the application layer, an indication of the set of QoE measurements and the unique identifier; and
including, by the access layer, the MCE identifier in the QoE reporting message based at least in part on the indication of the unique identifier obtained from the application layer.

26. The method of claim 22, further comprising:
including, at an access layer of the UE, an indication that the set of QoE measurements are available for transmission in the QoE reporting message;
receiving a bearer configuration for transmission of the set of QoE measurements based at least in part on the indication that the set of QoE measurements are available; and
transmitting a subsequent QoE reporting message indicating the set of QoE measurements based at least in part on the bearer configuration.

27. The method of claim 26, further comprising:
obtaining, at the access layer, the set of QoE measurements from an application layer of the UE, wherein the indication that the set of QoE measurements are available is based at least in part on the obtaining.

28. The method of claim 26, further comprising:
obtaining, at the access layer, the indication that the set of QoE measurements are available from an application layer of the UE, wherein the indication that the set of QoE measurements are available is based at least in part on the obtaining.

29. The method of claim 22, further comprising:
identifying a QoE reporting area for the set of QoE measurements based at least in part on the QoE measurement activation, the QoE reporting area being different from or the same as a QoE measurement area for the QoE measurement activation; and
determining that the UE is located within the QoE reporting area, wherein the QoE reporting message is transmitted based at least part on the UE being located within the QoE reporting area.

30. The method of claim 29, further comprising:
identifying the QoE reporting area at an application layer of the UE and based on at least one of the QoE measurement activation or an indication obtained from an access layer of the UE.

31. The method of claim 29, further comprising:
identifying the QoE reporting area at an access layer of the UE and based at least in part on an indication of the QoE reporting area received via radio resource signaling.

32. The method of claim 22, further comprising:
receiving a QoE configuration for the set of QoE measurements from a serving cell of the UE; and
determining that the MCE identifier is included in the QoE configuration, wherein the QoE reporting message is transmitted based at least in part on the MCE identifier being included in the QoE configuration.

33. The method of claim 32, wherein the QoE configuration is received in at least one a multicast control channel (MCCH) message, a radio resource control (RRC) message, a system information block (SIB) message, or a combination thereof, from the serving cell.

34. The method of claim 22, wherein the MCE identifier comprises at least one of an address, identifying information, a reference, a QoE server name, or a combination thereof, for an MCE associated with the QoE measurement activation.

35. A method for wireless communication at a network entity, comprising:
transmitting, to a user equipment (UE), a control message indicating a quality of experience (QoE) measurement activation for a set of QoE measurements by the UE, the control message indicating an application layer identifier associated with the QoE measurement activation; and
receiving, from the UE and based at least in part on the QoE measurement activation, a QoE reporting message including a measurement collection entity (MCE) identifier that corresponds to the application layer identifier and an indication of the set of QoE measurements.

36. The method of claim 35, further comprising:
mapping the MCE identifier to the set of QoE measurements, wherein the control message indicates the mapping.

37. The method of claim 35, wherein the indication of the set of QoE measurements comprises the set of QoE measurements.

38. The method of claim 35, further comprising:
identifying an indication that the set of QoE measurements are available for transmission based at least in part on the QoE reporting message;
transmitting a bearer configuration for transmission of the set of QoE measurements based at least in part on the indication that the set of QoE measurements are available; and
receiving a subsequent QoE reporting message indicating the set of QoE measurements.

39. The method of claim 35, further comprising:
indicating a QoE reporting area for the set of QoE measurements based at least in part on the QoE measurement activation, the QoE reporting area being different from or the same as a QoE measurement area for the QoE measurement activation; and
receiving the QoE reporting message based at least in part on the UE being located within the QoE reporting area.

40. The method of claim 35, further comprising:
transmitting a QoE configuration including the MCE identifier for the set of QoE measurements, wherein the QoE reporting message is received based at least in part on the MCE identifier being included in the QoE configuration.

41. The method of claim 40, wherein the QoE configuration is transmitted in at least one a multicast control channel (MCCH) message, a radio resource control (RRC) message, a system information block (SIB) message, or a combination thereof, from the network entity.

42. The method of claim 35, wherein the MCE identifier comprises at least one of an address, identifying information, a reference, a QoE server name, or a combination thereof, for an MCE associated with the QoE measurement activation.
